(19) United States
(12) Patent Application Publication
(10) Pub. No.: US 2025/0219230 A1
(43) Pub. Date: Jul. 3, 2025

(54) ELECTRICAL DEVICE AND CARRYING CASE

(71) Applicant: MAKITA CORPORATION, Anjo-shi (JP)

(72) Inventors: Junya YAMAGUCHI, Anjo-shi (JP); Akihiro NISHIMINE, Anjo-shi (JP); Hironori OGURA, Anjo-shi (JP); Shinya MIZUTANI, Anjo-shi (JP)

(73) Assignee: MAKITA CORPORATION, Anjo-shi (JP)

(21) Appl. No.: 18/985,277

(22) Filed: Dec. 18, 2024

(30) Foreign Application Priority Data
Dec. 27, 2023 (JP) 2023-221782
Sep. 30, 2024 (JP) 2024-170245

(51) Int. Cl. H01M 50/264; H01M 50/244; H01M 50/247; H01M 50/256; H01M 50/271

(52) U.S. Cl. CPC H01M 50/264; H01M 50/244; H01M 50/247; H01M 50/256; H01M 50/271

(57) ABSTRACT

An electrical device may include: a case body defining a housing space; a battery receptacle disposed on the case body, wherein a battery pack used as a power supply for a power tool is detachably attached to the battery receptacle; an external terminal disposed on the case body and configured to be electrically connected to the battery pack via the battery receptacle; a lid configured to be movable relative to the case body between an open position where the lid opens the housing space and a closed position where the lid closes the housing space; and a coupling mechanism configured to be switchable between a coupling state in which the coupling mechanism couples the case body and the lid to each other and a decoupled state in which the coupling mechanism decouples the case body and the lid from each other.

### REFERENCE TO RELATED APPLICATIONS

This application claims priority to Japanese Patent Application No. 2023-221782 filed on Dec. 27, 2023 and Japanese Patent Application No. 2024-170245 filed on Sep. 30, 2024. The entire contents of the priority applications are incorporated herein by reference.

### TECHNICAL FIELD

The disclosure herein relates to electrical devices and carrying cases.

### BACKGROUND ART

Japanese Patent Application Publication No. 2020-124781 describes an electrical device including a case body defining a housing space; a battery receptacle disposed on the case body, wherein a battery pack used as a power supply for a power tool is detachably attached to the battery receptacle; an external terminal disposed on the case body and configured to be electrically connected to the battery pack via the battery receptacle; a lid configured to be movable relative to the case body between an open position where the lid opens the housing space and a closed position where the lid closes the housing space; and a coupling mechanism configured to couple the case body and the lid to each other.

### SUMMARY

When using the electrical device of Japanese Patent Application Publication No. 2020-124781, the lid coupled to the case body may interfere with work of a user. For example, when the lid contacts against an object and this interrupts the installation of the electrical device, the use may be annoyed by such interference by the lid. Since the lid cannot be decoupled and removed from the case body in the electrical device of Japanese Patent Application Publication No. 2020-124781, the electrical device may interfere with the work of the user in instances such as the one above. The disclosure herein provides a technology that reduces such user inconvenience.

An electrical device disclosed herein may comprise: a case body defining a housing space; a battery receptacle disposed on the case body, wherein a battery pack used as a power supply for a power tool is detachably attached to the battery receptacle; an external terminal disposed on the case body and configured to be electrically connected to the battery pack via the battery receptacle; a lid configured to be movable relative to the case body between an open position where the lid opens the housing space and a closed position where the lid closes the housing space; and a coupling mechanism configured to be switchable between a coupling state in which the coupling mechanism couples the case body and the lid to each other and a decoupled state in which the coupling mechanism decouples the case body and the lid from each other.

The configuration above allows a user to decouple the lid from the case body by switching the coupling mechanism to the decoupled state. Thus, the user can remove the lid from the case body if the lid is interfering. The configuration above thus can reduce inconvenience for the user in using the electrical device.

A carrying case disclosed herein may be configured to allow a user to carry a battery pack used as a power supply for a power tool. The carrying case may comprise: a case body defining a housing space; a lid configured to be movable relative to the case body between an open position in which the lid opens the housing space and a closed position in which the lid closes the housing space; and a coupling mechanism configured to be switchable between a coupling state in which the coupling mechanism couples the case body and the lid to each other and a decoupled state in which the coupling mechanism decouples the case body and the lid from each other.

The configuration above allows the user to decouple the lid from the case body by switching the coupling mechanism to the decoupled state. Thus, the user can remove the lid from the case body if the lid is interfering. The configuration above thus can reduce inconvenience for the user in using the electrical device.

It should be noted that “closed position” of the lid used herein means not only the position in which the lid completely closes the housing space but also any position in which the lid slightly opens the housing space. For example, when the lid does not completely close the housing space but closes it to the point where an object (e.g., battery pack) cannot be put into or taken out from the housing space, this position of the lid can be construed as the closed position. Further, “coupling mechanism” used herein specifically intends a mechanism configured to be switchable between the coupling state and the decoupled state without the use of a tool (e.g., a screwdriver for tightening and loosening a screw). Thus, it should be noted that “coupling mechanism” used herein excludes mechanisms that require the use of a tool to be switched between the coupling state and the decoupled state.

### BRIEF DESCRIPTION OF DRAWINGS

FIG. 1 shows a charger 2 according to a first embodiment as viewed from the upper rear left side, where a lid 6 is in an open position.

FIG. 2 shows the charger 2 according to the first embodiment as viewed from the upper rear left side, where the lid 6 is in a closed position.

FIG. 3 shows a configuration of a tray member 10 of the charger 2 according to the first embodiment.

FIG. 4 shows a cross-sectional view illustrating the internal structure of the charger 2 according to the first embodiment.

FIG. 5 shows the charger 2 according to the first embodiment as viewed from the lower front right side, where the lid 6 is in the closed position.

FIG. 6 shows a configuration of a coupling mechanism 34 of the charger 2 according to the first embodiment.

FIG. 7 shows how a first coupling member 36 and a second coupling member 38 of the coupling mechanism 34 according to the first embodiment are removed.

FIG. 8 shows another diagram illustrating how the first coupling member 36 and the second coupling member 38 of the coupling mechanism 34 according to the first embodiment are removed.

FIG. 9 shows still another diagram illustrating how the first coupling member 36 and the second coupling member 38 of the coupling mechanism 34 according to the first embodiment are removed.

FIG. 10 shows the charger 2 according to the first embodiment with the lid 6 removed therefrom, where the charger 2 is placed on a placement surface P in a different orientation from the orientation shown in FIGS. 1 and 2.

FIG. 11 shows the charger 2 according to the first embodiment with the lid 6 removed therefrom, where the charger 2 is placed on the placement surface P in a different orientation from the orientations shown in FIGS. 1, 2, and 10.

FIG. 12 shows the lid 6 and a sealing member 110 according to the first embodiment as viewed from the lower front left side.

FIG. 13 shows the charger 2 according to the first embodiment as viewed from the upper rear left side, where a clear surface 112 and a textured surface 114 of the lid 6 are schematically visualized.

FIG. 14 shows a top view of the charger 2 according to the first embodiment, where the clear surface 112 and the textured surface 114 of the lid 6 are schematically visualized.

FIG. 15 shows the charger 2 according to the first embodiment as viewed from the lower front right side, where the clear surface 112 and the textured surface 114 of the lid 6 are schematically visualized.

FIG. 16 shows a front view of the charger 2 according to the first embodiment, where a left handle 124 is in a left lower position and a right handle 136 is in a right lower position.

FIG. 17 shows a front view of the charger 2 according to the first embodiment, where the left handle 124 is in a left upper position and the right handle 136 is in a right upper position.

FIG. 18 shows the charger 2 according to the first embodiment as viewed from the upper front left side, where a case body 4 is placed on the lid 6 and an engagement member 162 is in engagement with an engagement receiver 164.

FIG. 19 shows the engagement member 162 according to the first embodiment as viewed from the upper rear right side.

FIG. 20 shows the charger 2 according to the first embodiment, where the engagement member 162 is about to engage with the engagement receiver 164.

FIG. 21 shows a configuration of a tray member 204 of a charger 202 according to a second embodiment.

FIG. 22 schematically shows a configuration of a charger 302 according to a third embodiment.

FIG. 23 schematically shows a coupling mechanism 304 of the charger 302 according to the third embodiment, where a lid 6 is in the closed position.

FIG. 24 schematically shows the coupling mechanism 304 of the charger 302 according to the third embodiment, where the lid 6 is in the open position.

FIG. 25 schematically shows a configuration of a charger 402 according to a fourth embodiment.

FIG. 26 schematically shows a state of the charger 402 according to the fourth embodiment in which a lid 6 and a case body 4 are coupled to each other by a coupling mechanism 404L.

FIG. 27 schematically shows a state of the charger 402 according to the fourth embodiment in which coupling of the lid 6 with the case body 4 by the coupling mechanism 404L is decoupled.

FIG. 28 schematically shows a state of the charger 402 according to the fourth embodiment in which the lid 6 and the case body 4 are coupled to each other by a coupling mechanism 404R.

FIG. 29 schematically shows a state of the charger 402 according to the fourth embodiment in which coupling of the lid 6 with the case body 4 by the coupling mechanism 404R is decoupled.

FIG. 30 schematically shows how the lid 6 rotates about a shaft 410L with respect to the case body 4 in the charger 402 according to the fourth embodiment.

FIG. 31 schematically shows a configuration of a charger 502 according to a fifth embodiment.

FIG. 32 schematically shows a state of the charger 502 according to the fifth embodiment in which a lid 6 and a case body 4 are coupled to each other by a coupling mechanism 504.

FIG. 33 schematically shows a state of the charger 502 according to the fifth embodiment in which coupling of the lid 6 with the case body 4 by the coupling mechanism 504 is decoupled.

FIG. 34 schematically shows a configuration of a charger 602 according to a sixth embodiment.

FIG. 35 schematically shows a configuration of a charger 702 according to a seventh embodiment.

FIG. 36 schematically shows a state of the charger 702 according to the seventh embodiment in which a lid 6 and a case body 4 are coupled to each other by a coupling mechanism 704.

FIG. 37 schematically shows a state of the charger 702 according to the seventh embodiment in which coupling of the lid 6 with the case body 4 by the coupling mechanism 704 is decoupled.

FIG. 38 schematically shows a state of a charger 702 according to a variant of the seventh embodiment in which a lid 6 and a case body 4 are coupled to each other by a coupling mechanism 704.

FIG. 39 schematically shows a state of the charger 702 according to the variant of the seventh embodiment in which coupling of the lid 6 with the case body 4 by the coupling mechanism 704 is decoupled.

FIG. 40 schematically shows how a lid 6 rotates about a first rotation axis A1 with respect to a case body 4 in a charger 802 according to an eighth embodiment.

FIG. 41 schematically shows how the lid 6 rotates about a second rotation axis A2 with respect to the case body 4 in the charger 802 according to the eighth embodiment.

FIG. 42 shows a configuration of a retainer 96 of the charger 802 according to the eighth embodiment.

FIG. 43 shows a state of the charger 802 according to the eighth embodiment in which the lid 6 and the case body 4 are coupled to each other by the retainer 96.

FIG. 44 schematically shows a configuration of charging state displays 28 of the charger 2 according to the first embodiment.

### DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved electrical devices and carrying cases as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, when the lid is in the closed position, switching of the coupling mechanism from the coupling state to the decoupled state may be prohibited. When the lid is in the open position, the switching of the coupling mechanism from the coupling state to the decoupled state may be permitted.

For example, from a perspective of safety, a user may wish to prevent decoupling of the lid from the case body when the posture of the electrical device is unstable (e.g., when the user is carrying the electrical device). Normally, the lid is expected to be in the closed position when the posture of the electrical device is unstable. According to the configuration above, the lid is prohibited from being decoupled from the case body when the lid is in the closed position. The lid is permitted to be decoupled from the case body when the lid is in the open position. Thus, the configuration above prevents the lid from being decoupled from the case body when the posture of the electrical device is unstable, and thus improves the safety of the electrical device.

In one or more embodiments, the coupling mechanism may comprise a coupling member configured to be movable between a coupling position in which the coupling member couples the case body and the lid to each other and a decoupled position in which the coupling member decouples the case body and the lid from each other. The coupling state may be a state in which the coupling member is in the coupling position. The decoupled state may be a state in which the coupling member is in the decoupled position.

The configuration above allows the user to switch the coupling mechanism between the coupling state and the decoupled state by changing the position of the coupling member between the coupling position and the decoupled position. This allows for a simple configuration of the coupling mechanism.

In one or more embodiments, the coupling member may be attached on an outer surface of one of the case body and the lid.

According to the configuration above, the coupling member is disposed at a place the user can easily access.

In one or more embodiments, the coupling member may comprise an engagement portion configured to engage with one of the case body and the lid when the coupling member is in the coupling position.

According to the configuration above, the user needs to disengage the engagement portion from one of the case body and the lid before moving the coupling member from the coupling position to the decoupled position. This prevents the coupling member from moving from the coupling position to the decoupled position when the user does not intend to do so (i.e., decoupling of the lid from the case body can be suppressed from occurring unexpectedly).

In one or more embodiments, one of the case body and the lid may comprise a blocking portion configured to block movement of the coupling member from the coupling position to the decoupled position when the lid is in the closed position. The blocking portion may not block the movement of the coupling member from the coupling position to the decoupled position when the lid is in the open position.

For example, from the perspective of safety, the user may wish to prevent decoupling of the lid from the case body when the posture of the electrical device is unstable (e.g., when the user is carrying the electrical device). Normally, the lid is expected to be in the closed position when the posture of the electrical device is unstable. According to the configuration above, the lid is prevented from being decoupled from the case body when the lid is in the closed position since the blocking portion blocks the movement of the coupling member from the coupling position to the decoupled position. Thus, the configuration above prevents the lid from being decoupled from the case body when the posture of the electrical device is unstable, and thus improves the safety of the electrical device.

In one or more embodiments, the coupling member may comprise: a coupling pin configured to be inserted in both a case-side insertion element located on the case body and a lid-side insertion element located on the lid to couple the case body and the lid to each other such that the case body and the lid are rotatable relative to each other; and a manipulatable portion fixed to the coupling pin and configured to be manipulated by a user. The coupling position may be a position in which the coupling pin is inserted in both the case-side insertion element and the lid-side insertion element. The decoupled position may be a position in which the coupling pin is out of at least one of the case-side insertion element and the lid-side insertion element.

The configuration above allows the user to switch the coupling mechanism between the coupling state and the decoupled state by sliding the coupling member in the axial direction of the coupling pin to insert/pull the coupling pin into/out of the case-side insertion element and the lid-side insertion element. This allows for a simple configuration of the coupling mechanism.

In one or more embodiments, the manipulatable portion may comprise a finger pad configured for the user to put a finger on. The finger pad may be offset from the coupling pin in a radial direction of the coupling pin.

The configuration above allows the user to move the coupling member with his/her finger on the finger pad of the coupling member without using a special tool. However, if the finger pad and the coupling pin are aligned in the axial direction of the coupling pin, this may result in an increased size of the coupling member in the axial direction of the coupling pin. In the configuration above, the finger pad is offset from the coupling pin in the radial direction of the coupling pin, and thus the finger pad and the coupling pin are not aligned in the axial direction of the coupling pin. This allows for a reduction in the size of the coupling member in the axial direction of the coupling pin.

In one or more embodiments, the manipulatable portion may comprise a wall extending in a direction perpendicular to an axial direction of the coupling pin and configured to allow a plate element to contact thereto. The wall may be offset from the coupling pin in a radial direction of the coupling pin.

The configuration above allows the user to apply a force against the coupling member in the axial direction of the coupling pin via a plate element (e.g., a coin, a flathead screwdriver, etc.) by bringing the plate element into contact with the wall of the coupling member. However, if the wall and the coupling pin are aligned in the axial direction of the coupling pin, this may result in an increased size of the coupling member in the axial direction of the coupling pin. In the configuration above, the wall is offset from the coupling pin in the radial direction of the coupling pin, and thus the wall and the coupling pin are not aligned in the axial direction of the coupling pin. This allows for a reduction in the size of the coupling member in the axial direction of the coupling pin.

In one or more embodiments, the battery receptacle may be disposed within the housing space.

If the battery receptacle is disposed outside the housing space (e.g., on the outer surface of the case body), a battery pack attached on the battery receptacle is exposed to the outside of the housing space. In this case, the battery pack may collide with an object (e.g., a tool, the ground, a wall) and be damaged. According to the configuration above, the battery receptacle is disposed within the housing space, and thus the battery pack attached on the battery receptacle is not exposed to the outside of the housing space. The battery pack is thus prevented from colliding with an object and being damaged.

In one or more embodiments, the battery pack may be attached to the battery receptacle by being slid along a predetermined sliding direction relative to the battery receptacle. The sliding direction may be along a direction in which the housing space is opened.

The configuration above allows the user to easily attach/detach the battery pack to/from the battery receptacle.

In one or more embodiments, the electrical device may further comprise a manipulatable portion configured to be manually manipulated by a user. The coupling mechanism may be switched between the coupling state and the decoupled state by the manipulatable portion being manipulated.

The configuration above allows the user to switch the coupling mechanism between the coupling state and the decoupled state by manually manipulating the manipulatable portion, without using a tool (e.g., a screwdriver, a wrench). This allows the user to easily switch the coupling mechanism between the coupling state and the decoupled state.

In one or more embodiments, the coupling state may include: a first coupling state in which the coupling mechanism couples the case body and the lid to each other such that the case body and the lid are rotatable relative to each other about a first rotation axis; and a second coupling state in which the coupling mechanism couples the case body and the lid to each other such that the case body and the lid are rotatable relative to each other about a second rotation axis different from the first rotation axis. The coupling mechanism may be configured to be switchable between the first coupling state, the second coupling state, and the decoupled state.

According to the configuration above, an opening direction of the lid relative to the case body can be changed by switching the coupling mechanism between the first coupling state and the second coupling state. This allows the user to change the opening direction of the lid relative to the case body according to the user's convenience.

In one or more embodiments, the carrying case may further comprise a battery receptacle disposed on the case body. The battery pack may be detachably attached to the battery receptacle.

According to the configuration above, the battery pack is positioned with respect to the carrying case by attaching the battery pack to the battery receptacle.

### First Embodiment: Charger 2

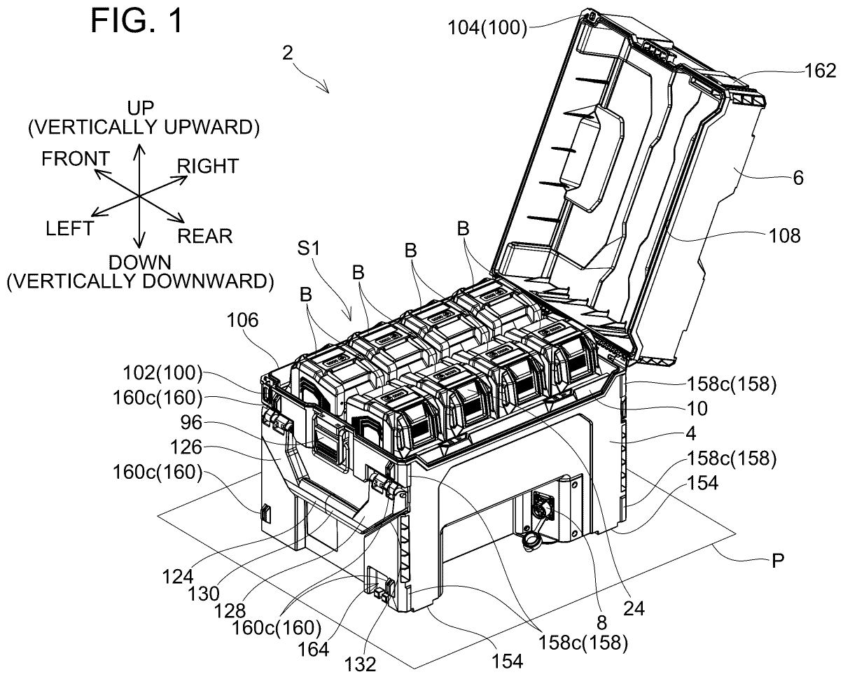

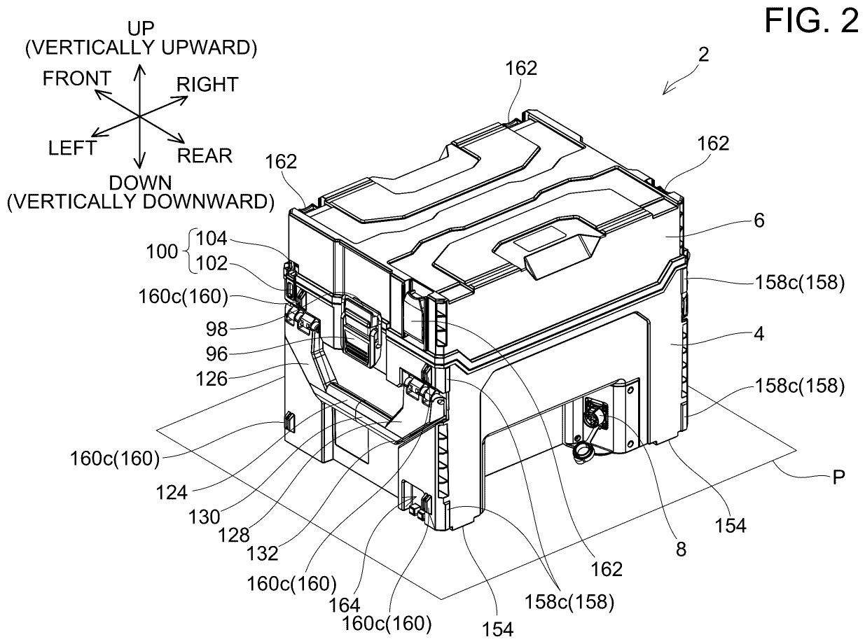

A charger 2 shown in FIG. 1 is an electrical device configured to charge a plurality of battery packs B. The charger 2 has a substantially cuboid shape. The charger 2 comprises a case body 4 defining a housing space S1 for housing one or more objects (e.g., the battery packs B) and a lid 6 configured to open and close the housing space S1. In this embodiment, for example, a PC+ABS resin (polycarbonate polymer alloy) is used for the case body 4. For example, PC (polycarbonate) is used for the lid 6. The lid 6 is movable relative to the case body 4 between an open position where the lid 6 opens the housing space S1 (see FIG. 1) and a closed position where the lid 6 closes the housing space S1 (see FIG. 2). A user can remove/put an object from/into the housing space S1 when the lid 6 is in the open position. An external terminal 8 is disposed on the case body 4 to connect a dedicated AC adaptor (not shown). The AC adaptor converts AC power supplied from an external power supply, such as a commercial power supply to DC power and supplies it to the charger 2.

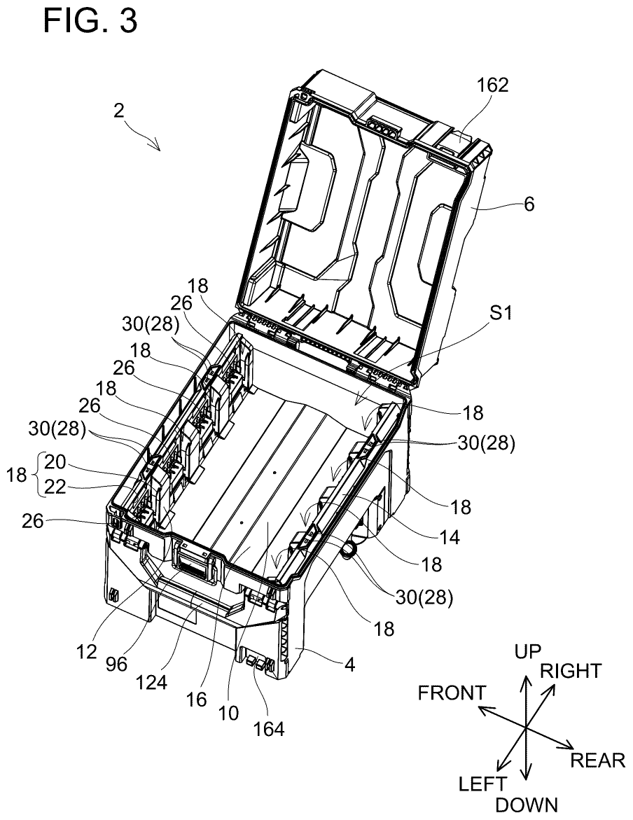

As shown in FIGS. 1 and 2, the charger 2 can be placed on a placement surface P such as the ground such that the housing space S1 is open vertically upward and the top surface of the lid 6 is directed vertically upward when the lid 6 is in the closed position. Here, “vertically upward” can be rephrased as a direction perpendicular to the placement surface P. In the disclosure herein, a front-rear direction, a left-right direction, and an up-down direction of the charger 2 are defined based on the orientation of the charger 2 shown in FIGS. 1 and 2. Specifically, the up-down direction of the charger 2 is defined as a vertically up-down direction when the charger 2 is in the orientation shown in FIGS. 1 and 2; the left-right direction of the charger 2 is defined as a direction that is perpendicular to the up-down direction and along the longitudinal direction of the charger 2; and the front-rear direction of the charger 2 is defined as the direction perpendicular to the up-down direction and the left-right direction. Regarding the front-rear direction, the rear direction is toward the external terminal 8 and the front direction is the opposite direction. In some of FIGS. 3 to 21 (specifically, in FIGS. 3 to 9 and 12 to 20), the depiction of the placement surface P is omitted.

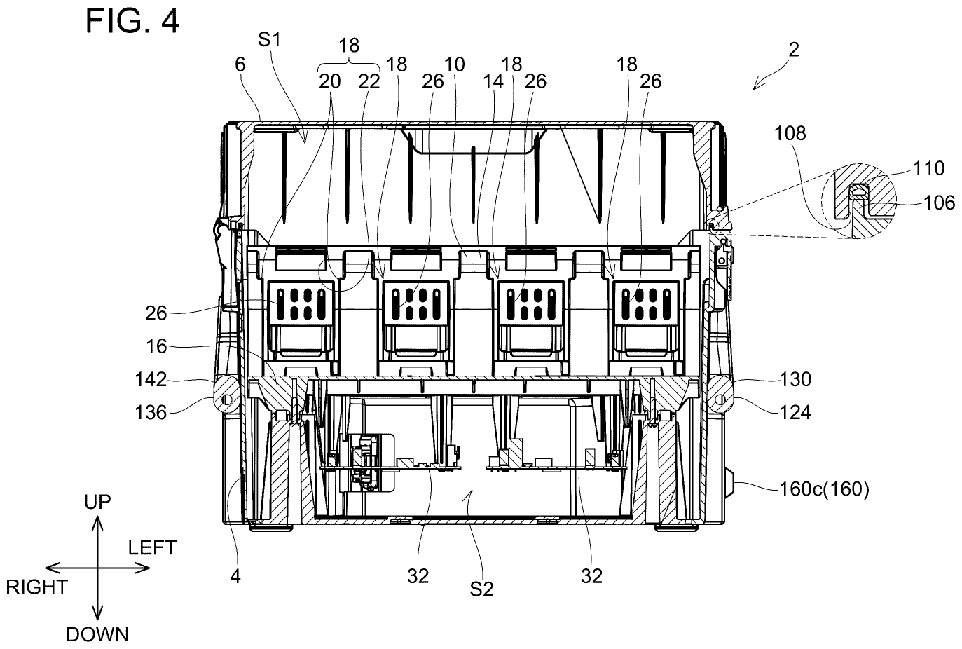

As shown in FIG. 3, a tray member 10 is fixed to the case body 4. The tray member 10 comprises a front wall 12, a rear wall 14, and a bottom wall 16. The front wall 12 extends in the up-down direction and the left-right direction along the front wall of the case body 4. The rear wall 14 extends in the up-down direction and the left-right direction along the rear wall of the case body 4. As shown in FIG. 4, the bottom wall 16 is separated from the bottom wall of the case body 4 and extends in the front-rear direction and the left-right direction. As shown in FIG. 3, eight battery receptacles 18 are located on the tray member 10. Four of the battery receptacles 18 are located on the rear surface of the front wall 12 and the other four battery receptacles 18 are located on the front surface of the rear wall 14. Each battery receptacle 18 comprises a guide rail 20 and a latch receiver 22. To attach a battery pack B (see FIG. 1) to a battery receptacle 18, the battery pack B is slid downward relative to the battery receptacle 18. In the course of attachment, the guide rail 20 is inserted into a guide groove (not shown) defined in the battery pack B and a latch 24 (see FIG. 1) located on the battery pack B engages with the latch receiver 22. Once the insertion and engagement have been completed, the attachment of the battery pack B is completed. To detach the battery pack B from the battery receptacle 18, the latch 24 is disengaged from the latch receiver 22 by a manipulation onto the latch 24 and then the battery pack B is slid upward relative to the battery receptacle 18. Once the guide rail 20 has been pulled out from the guide groove of the battery pack B, the detachment of the battery pack B is completed. Further, eight connection terminals 26 (some of these are not shown) are located on the rear surface of the front wall 12 and the front surface of the rear wall 14. Each of the connection terminals 26 is assigned to corresponding one of the battery receptacles 18. The connection terminals 26 are electrically connected to the battery packs B attached in the battery receptacles 18. When the charger 2 charges the battery packs B, electric power is supplied from the charger 2 to the battery packs B via the connection terminals 26. Further, eight charging state displays 28 are located on upper surfaces of the front wall 12 and the rear wall 14. Each of the charging state displays 28 is assigned to corresponding one of the battery receptacles 18.

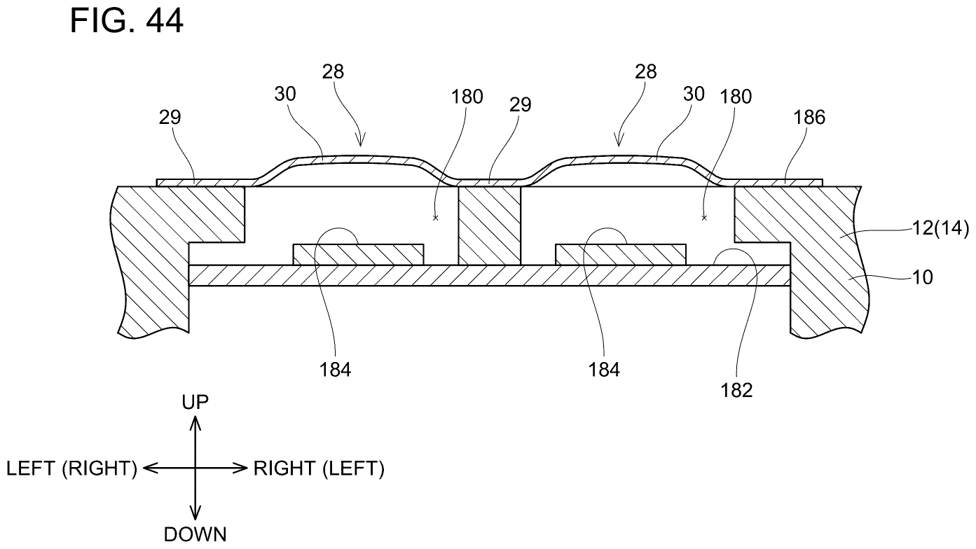

As shown in FIG. 44, each charging state display 28 comprises a cavity 180 extending though the upper surface of the front wall 12 (or the upper surface of the rear wall 14) in the up-down direction and a light emitter 184. Each pair of the charging state displays 28 share a display substrate 182 disposed in their cavities 180 and a label member 186 disposed on the upper surface of the front wall 12 (or the upper surface of the rear wall 14) to cover their cavities 180. The light emitters 184 are mounted on the upper surface of the display substrate 182. The label member 186 is a plate-shaped member constituted of a synthetic resin and has visible light permeability. The label member 186 comprises a flat portion 29 disposed on the upper surface of the front wall 12 (or the upper surface of the rear wall 14) and convex portions 30 projecting upward from the flat portion 29. A projection length of the convex portions 30 from the flat portion 29 (i.e., a distance in the up-down direction from the upper surface of the flat portion 29 to the upper surfaces of the convex portions 30) ranges from approximately 0.5 mm to approximately 1.0 mm. In a variant, the projection length of the convex portions 30 may be greater than 1.0 mm.

The flat portion 29 is a portion of the label member 186 that faces the upper surface of the front wall 12 (or the upper surface of the rear wall 14) (i.e., a portion of the label member 186 that does not face the cavities 180). The convex portions 30 are portions of the label member 186 that face the cavities 180. Thus, visible light emitted from the light emitters 184 passes through the convex portions 30 of the label member 186 and radiates to the outside of the tray member 10. The user can thus see the visible light from the light emitters 184 through the convex portions 30. The charging state displays 28 display charging states of the battery packs B attached on the battery receptacles 18 (see FIG. 3) by means of the visible light emitted by the light emitters 184. For example, the charging state displays 28 display that the battery packs B are being charged, that the battery packs B are fully charged, and that an abnormality (e.g., overcurrent) has occurred while the battery packs B are charged.

In this embodiment, the shape of the convex portions 30 is rectangular as viewed from above. In a variant, the shape of the convex portions 30 may be other than a rectangle (e.g., may be circular) as viewed from above. A surface treatment is applied to the upper surfaces of the convex portions 30 to diffuse the visible light from the light emitters 184, although this is not shown. For example, a pattern similar to a grain texture (creases) of leather products is formed on the upper surfaces of the convex portions 30. This surface treatment facilitates evenly spreading the visible light from the light emitters 184 over the entire convex portions 30 and thus allows the user to easily check the light-emitting states of the light emitters 184.

The battery packs B shown in FIG. 1 are each used as a power supply for a power tool (e.g., a driver, a drill, a grinder, a circular saw, a chainsaw, a reciprocating saw, a lawn mower, a brush cutter, a hedge trimmer, a blower, and other tool used in fields such as construction, manufacturing, gardening, civil engineering, etc.), which is not shown, and configured to be detachably attached to the power tool. The weight of a single battery pack B is for example two kilograms. The weight of the charger 2 with none of the battery packs B attached in any of the eight battery receptacles 18 is for example six kilograms. Thus, the weight of the charger 2 with the battery packs B attached in all of the eight battery receptacles 18 is for example 22 kilograms.

As shown in FIG. 4, the charger 2 further comprises a control board 32 configured to control the charger 2. The control board 32 is located in a board space S2 which is defined by the case body 4 and located below the tray member 10. The housing space S1 and the board space S2 are separated from each other by the tray member 10. The control board 32 is electrically connected to the external terminal 8, the connection terminals 26, and the charging state displays 28 via wires (not shown) located in the board space S2. The control board 32 can charge the battery packs B for example by supplying electric power supplied to the charger 2 via the external terminal 8 to the battery packs B via the connection terminals 26.

### Coupling Mechanism 34

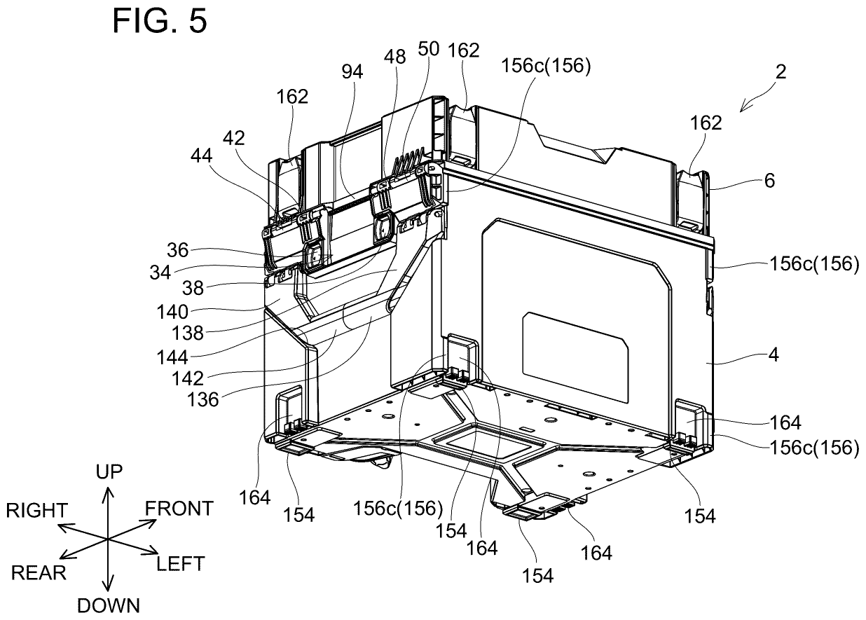

As shown in FIG. 5, the charger 2 further comprises a coupling mechanism 34 that couples the case body 4 and the lid 6 to each other. The coupling mechanism 34 is located on the right surface of the charger 2. The coupling mechanism 34 comprises a first coupling member 36 and a second coupling member 38 located forward of the first coupling member 36. The first coupling member 36 and the second coupling member 38 are detachably attached to the case body 4.

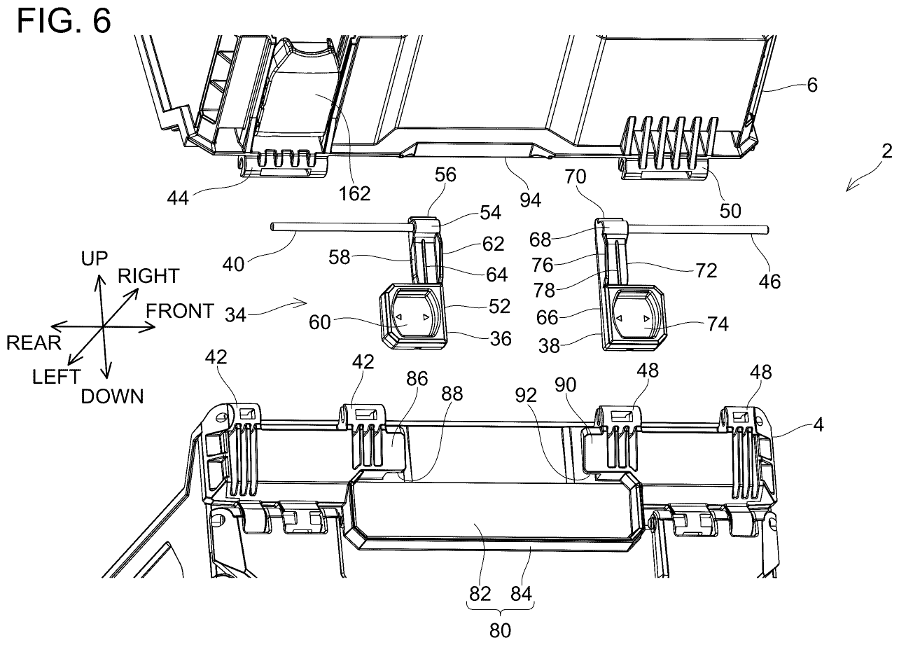

As shown in FIG. 6, the first coupling member 36 comprises a first coupling pin 40. The first coupling pin 40 extends in the front-rear direction. A first case-side tube 42 is located on the case body 4, and the first case-side tube 42 is configured to allow the first coupling pin 40 to be inserted therein. A first lid-side tube 44 is located on the lid 6, and the first lid-side tube 44 is configured to allow the first coupling pin 40 to be inserted therein. The first coupling pin 40 is inserted in both the first case-side tube 42 and the first lid-side tube 44 to couple the case body 4 and the lid 6 such that they are rotatable to each other. The second coupling member 38 comprises a second coupling pin 46. The second coupling pin 46 extends in the front-rear direction. A second case-side tube 48 is located on the case body 4, and the second-case-side tube 48 is configured to allow the second coupling pin 46 to be inserted therein. A second lid-side tube 50 is located on the lid 6, and the second lid-side tube 50 is configured to allow the second coupling pin 46 to be inserted therein. The second coupling pin 46 is inserted in both the second case-side tube 48 and the second lid-side tube 50 to couple the case body 4 and the lid 6 such that they are rotatable to each other. Thus, the lid 6 is movable between the open position shown in FIG. 1 and the closed position shown in FIG. 2 by rotating about the first coupling pin 40 and the second coupling pin 46. In the disclosure herein, an opening degree of the lid 6 (i.e., how much the lid 6 is opened) is expressed in a rotation angle of the lid 6 relative to the closed position. The opening degree of the lid 6 in the open position shown in FIG. 1 is for example in a range from 45 degrees to 180 degrees, and in this embodiment, it is 115 degrees.

As shown in FIG. 6, the first coupling member 36 further comprises a first manipulatable portion 52. The first manipulatable portion 52 comprises a holding portion 54 holding the front end of the first coupling pin 40, a projection 56 projecting upward from the holding portion 54, an extension 58 extending downward from the holding portion 54, a finger pad 60 connected to the lower end of the extension 58, a wall 62 connected to the front end of the extension 58, and an engagement rib 64 located on the right surface of the extension 58. The wall 62 extends in the up-down direction and the left-right direction (directions perpendicular to the axial direction of the first coupling pin 40). The finger pad 60, the wall 62, and the engagement rib 64 are offset downward (in the radial direction of the first coupling pin 40) from the first coupling pin 40. The second coupling member 38 further comprises a second manipulatable portion 66. The second manipulatable portion 66 comprises a holding portion 68, a projection 70, an extension 72, a finger pad 74, a wall 76, and an engagement rib 78. Descriptions for these elements of the second manipulatable portion 66 are omitted since the configuration of the second manipulatable portion 66 is in mirror symmetry to the configuration of the first manipulatable portion 52 of the first coupling member 36.

A guide 80 is located on the case body 4, and the guide 80 is configured to receive the first manipulatable portion 52 and the second manipulatable portion 66 such that they are slidable in the front-rear direction (in the axial direction of the coupling pins 40, 46). The guide 80 comprises a guide surface 82 that contacts the left surfaces of the first manipulatable portion 52 and the second manipulatable portion 66 such that they are slidable in the front-rear direction; and a guide wall 84 that supports the lower ends of the first manipulatable portion 52 and the second manipulatable portion 66 such that they are slidable in the front-rear direction. An engagement piece 86 is located on a portion of the case body 4 that faces the right surface of the extension 58. An engagement groove 88 configured to engage with the engagement rib 64 is defined in the left surface of the engagement piece 86. Similarly, an engagement piece 90 is located on a portion of the case body 4 that faces the right surface of the extension 72. An engagement groove 92 configured to engage with the engagement rib 78 is defined in the left surface of the engagement piece 90.

As shown in FIG. 5, the first coupling member 36 and the second coupling member 38 are typically attached on the outer surface of the case body 4. That is, the first coupling member 36 is attached on the case body 4 such that the first coupling pin 40 (see FIG. 6) is inserted in both the first case-side tube 42 and the first lid-side tube 44 and the engagement rib 64 (see FIG. 6) is engaged with the engagement groove 88 (see FIG. 6). The position of the first coupling member 36 in this state is herein termed “first coupling position”. Further, the second coupling member 38 is attached on the case body 4 such that the second coupling pin 46 (see FIG. 6) is inserted in both the second case-side tube 48 and the second lid-side tube 50 and the engagement rib 78 (see FIG. 6) is engaged with the engagement groove 92 (see FIG. 6). The position of the second coupling member 38 in this state is herein termed “second coupling position”.

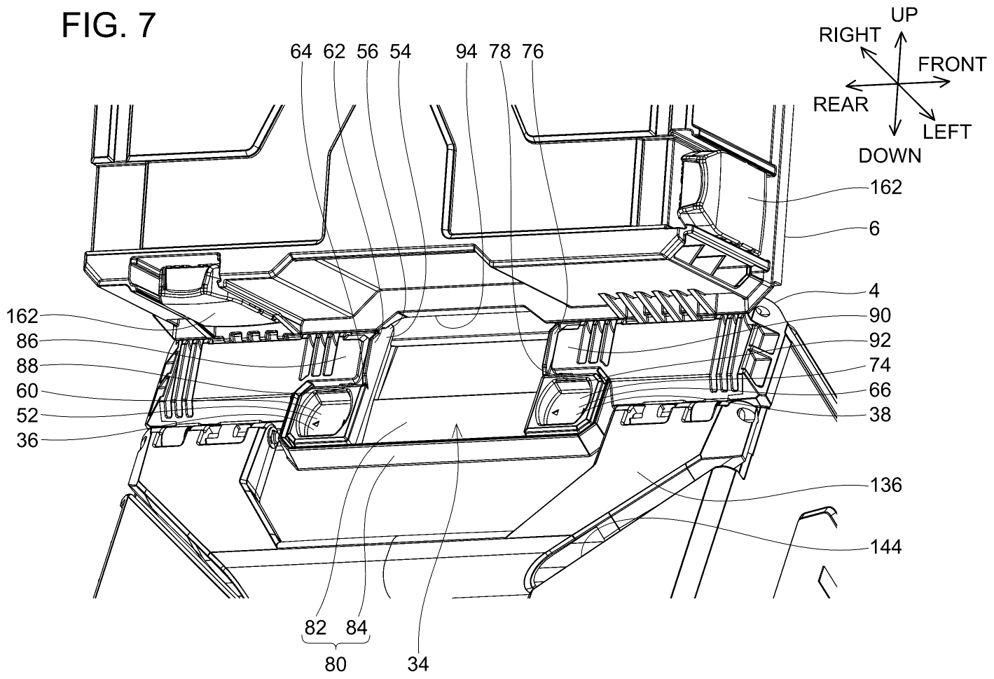

A blocking projection 94 is located on the lid 6. The blocking projection 94 projects downward from the lower end of the right wall of the lid 6. As the lid 6 in the closed position is viewed in the front-rear direction (in the axial direction of the coupling pins 40, 46), the blocking projection 94 overlaps the projection 56 of the first coupling member 36 (the projection 70 of the second coupling member 38) (see FIG. 6). In this state, the projection 56 (the projection 70) is blocked by the blocking projection 94 when the user attempts to move the first coupling member 36 (the second coupling member 38) forward (rearward) from the first coupling position (the second coupling position). Thus, the first coupling member 36 (the second coupling member 38) is prevented from further moving forward (rearward). However, as shown in FIG. 7, once the opening degree of the lid 6 exceeds a predetermined blocking avoidance degree, the blocking projection 94 no longer overlaps the projection 56 (the projection 70) (see FIG. 6) as the lid 6 is viewed in the front-rear direction (in the axial direction of the coupling pins 40, 46). Thus, the projection 56 (the projection 70) is no longer blocked by the blocking projection 94 when the first coupling member 36 (the second coupling member 38) is moved forward (rearward) from the first coupling position (the second coupling position). Thus, the first coupling member 36 (the second coupling member 38) is permitted to be moved in the front-rear direction (in the axial direction of the coupling pins 40, 46). The blocking avoidance degree here is for example in a range from 45 degrees to 180 degrees, and in this embodiment, it is 90 degrees.

Once the opening degree of the lid 6 exceeds the blocking avoidance degree, the user can disengage the engagement rib 64 from the engagement groove 88 by applying a forward force on the first coupling member 36 and then move the first coupling member 36 forward from the first coupling position. When applying the forward force, the user may put a finger on the finger pad 60 and apply the forward force on the finger pad 60 (the first coupling member 36). Alternatively, the user may insert a plate-shaped object (not shown), such as a coin, into a clearance between the rear surface of the wall 62 and the front surface of the engagement piece 86 and use the plate-shaped object according to the principle of leverage to apply the forward force on the wall 62 (the first coupling member 36). In this case, a portion of the plate-shaped object that contacts the engagement piece 86 is the fulcrum, a portion of the plate-shaped object that contacts the user is the effort, and a portion of the plate-shaped object that contacts the wall 62 is the load.

Further, once the opening degree of the lid 6 exceeds the blocking avoidance degree, the user can disengage the engagement rib 78 from the engagement groove 92 by applying a rearward force on the second coupling member 38 and then move the second coupling member 38 rearward from the second coupling position. When applying the rearward force, the user may put a finger on the finger pad 74 and apply the rearward force on the finger pad 74 (the second coupling member 38). Alternatively, the user may insert a plate-shaped object (not shown), such as a coin, into a clearance between the front surface of the wall 76 and the rear surface of the engagement piece 90 and use the plate-shaped object according to the principle of leverage to apply the rearward force on the wall 76 (the second coupling member 38). In this case, a portion of the plate-shaped object that contacts the engagement piece 90 is the fulcrum, a portion of the plate-shaped object that contacts the user is the effort, and a portion of the plate-shaped object that contacts the wall 76 is the load.

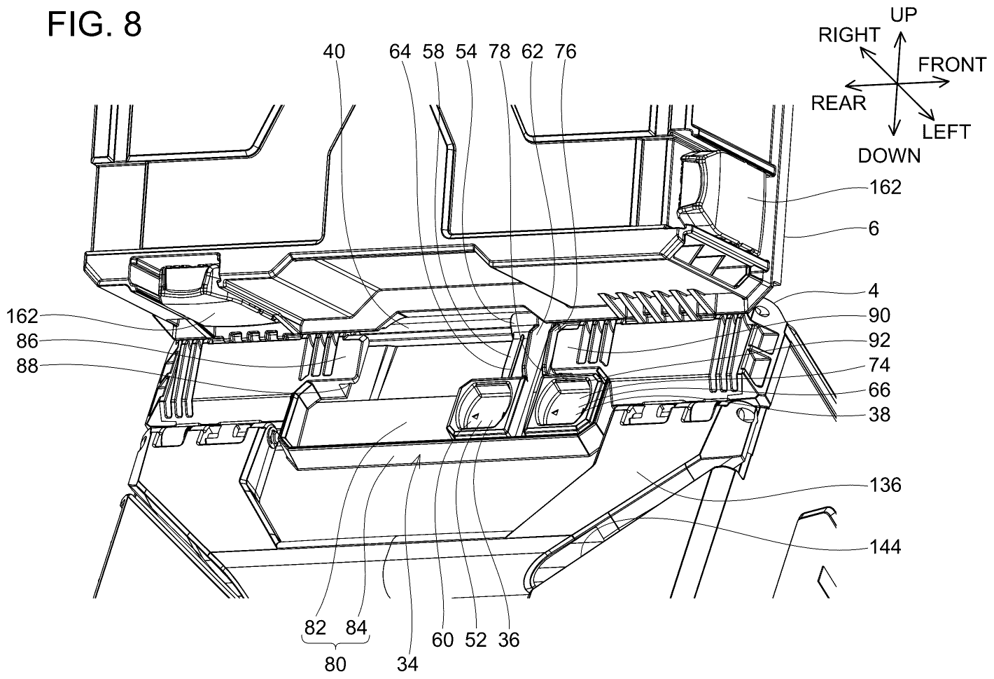

As shown in FIG. 8, as the first coupling member 36 is moved forward from the first coupling position (the position shown in FIG. 7), the first coupling pin 40 is pulled out from the first lid-side tube 44 (see FIG. 6), thereby the coupling of the case body 4 with the lid 6 formed by the first coupling pin 40 is released. In the disclosure herein, the position of the first coupling member 36 upon when the first coupling pin 40 has just been pulled out from the first lid-side tube 44 is termed “first decoupled position”. As the first coupling member 36 is further moved forward, the first coupling pin 40 is also pulled out from the first case-side tube 42 (see FIG. 6). In this state, the first coupling member 36 can be detached from the case body 4. The second coupling member 38 in the second coupling position does not interrupt the first coupling member 36 while the first coupling pin 40 is being pulled out from the first case-side tube 42 and the first lid-side tube 44.

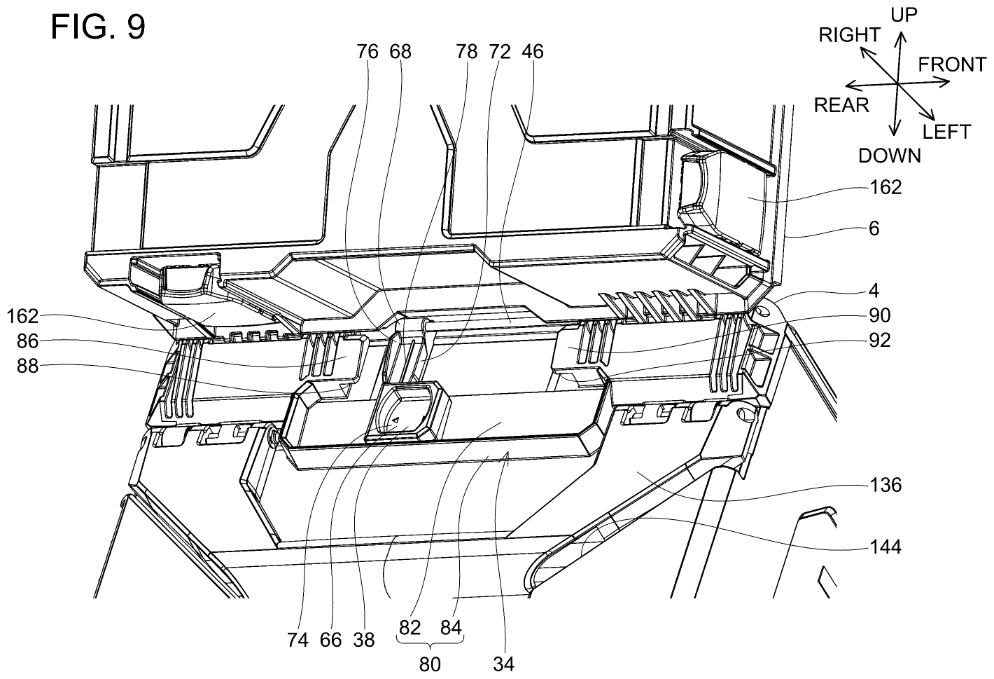

As shown in FIG. 9, as the second coupling member 38 is moved rearward from the second coupling position (the position shown in FIGS. 7 and 8), the second coupling pin 46 is pulled out from the second lid-side tube 50 (see FIG. 6), thereby the coupling of the case body 4 with the lid 6 formed by the second coupling pin 46 is released. In the disclosure herein, the position of the second coupling member 38 upon when the second coupling pin 46 has just been pulled out from the second lid-side tube 50 is termed “second decoupled position”. As the second coupling member 38 is further moved rearward, the second coupling pin 46 is also pulled out from the second case-side tube 48 (see FIG. 6). In this state, the second coupling member 38 can be detached from the case body 4.

In the example shown in FIGS. 7-9, the second coupling member 38 is detached after the first coupling member 36 has been detached first. However, the first coupling member 36 may be detached after the second coupling member 38 has been detached first.

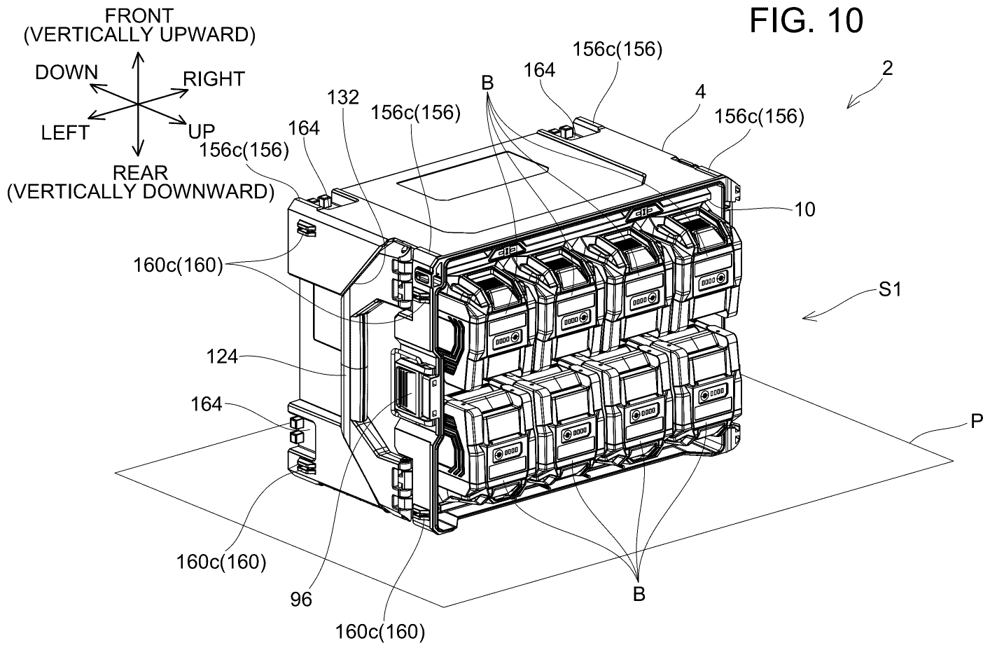

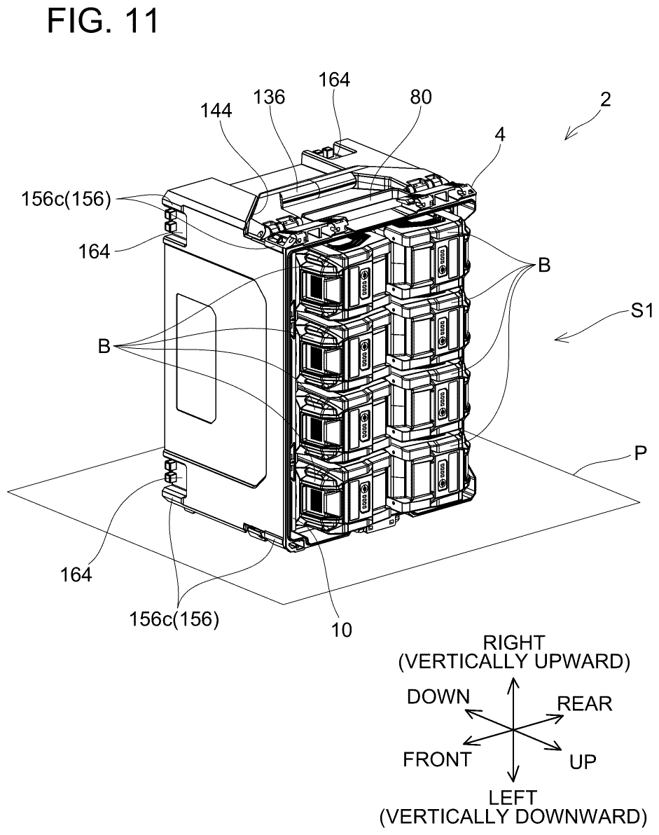

In this embodiment, one of the first coupling member 36 and the second coupling member 38 is first detached from the case body 4 and then the other of the first coupling member 36 and the second coupling member 38 is moved to the decoupled position, so that the case body 4 and the lid 6 are decoupled from each other and the lid 6 can thus be detached from the case body 4. Leaving the charger 2 without the lid 6 attached in the case body 4, as shown in FIGS. 10 and 11, allows the user to access the housing space S1 without an effort to open the lid 6. Thus, the user can access the housing space S1 easily. Further, the charger 2 without the lid 6 is smaller in size, and thus a space required to install the charger 2 is reduced.

To attach the lid 6 again to the case body 4 after it has been detached from the case body 4, as shown in FIG. 6, the lid 6 is first positioned relative to the case body 4 such that the first lid-side tube 44, the first case-side tube 42, the second case-side tube 48, and the second lid-side tube 50 are aligned in their axial direction. Then, the orientation of the lid 6 is adjusted relative to the case body 4 such that the opening degree of the lid 6 exceeds the blocking avoidance degree, and after that, the first coupling member 36 and the second coupling member 38 are attached. The first coupling member 36 and the second coupling member 38 are attached by performing the steps for detaching the first coupling member 36 and the second coupling member 38, which were described referring to FIGS. 7 to 9, in the reverse order, and thus how the first coupling member 36 and the second coupling member 38 are attached is not described in detail here.

### Retainer 96 and Locking Section 100

As shown in FIG. 2, a retainer 96 (e.g., a draw latch) for retaining the lid 6 in the closed position is located on the left surface of the case body 4. A groove 98 for the retainer 96 is defined in the lid 6. Further, a locking section 100 is located on the left surface of the charger 2 and forward of the retainer 96 and the groove 98, and the locking section 100 is configured to be locked with a padlock (not shown). The locking section 100 comprises a case-side lock hole 102 defined in the case body 4 and a lid-side lock hole 104 defined in the lid 6. The user can lock the locking section 100 by inserting the shackle of a padlock into the case-side lock hole 102 and the lid-side lock hole 104. While the locking section 100 is locked, the lid 6 is prohibited from moving from the closed position to the open position. Specifically, while the locking section 100 is locked, the lid 6 cannot be opened enough for an object (e.g., a battery pack B) to be removed from or put into the housing space S1.

### Sealing Member 110

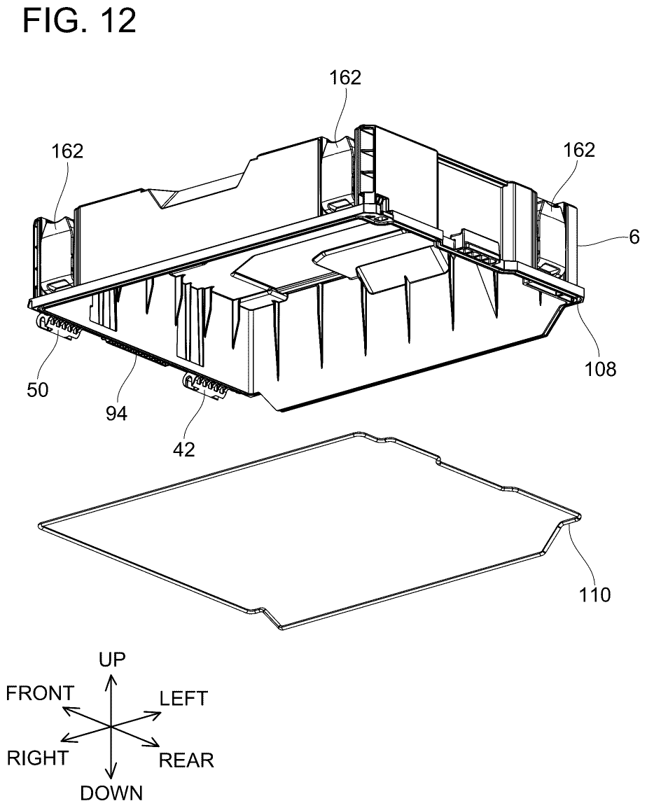

As shown in FIG. 1, an engagement groove 108 configured to receive an opening edge 106 of the case body 4 is defined in the lid 6. The engagement groove 108 is defined along ends of side walls of the lid 6. As shown in FIG. 12, a sealing member 110 is housed in the engagement groove 108. When the lid 6 is in the closed position as shown in FIG. 4, the opening edge 106 of the case body 4 is received in the engagement groove 108, and the sealing member 110 housed in the engagement groove 108 is compressed between the opening edge 106 of the case body 4 and the bottom surface of the engagement groove 108. Thus, when the lid 6 is in the closed position, the sealing member 110 provides sealing between the case body 4 and the lid 6. This prevents a liquid such as water from entering the case body 4 (i.e., the housing space S1) from the outside.

### Surface Treatment on Lid 6

In this embodiment, the lid 6 has visible light permeability. Thus, the user can see the inside (i.e., the housing space S1) of the case body 4 through the lid 6.

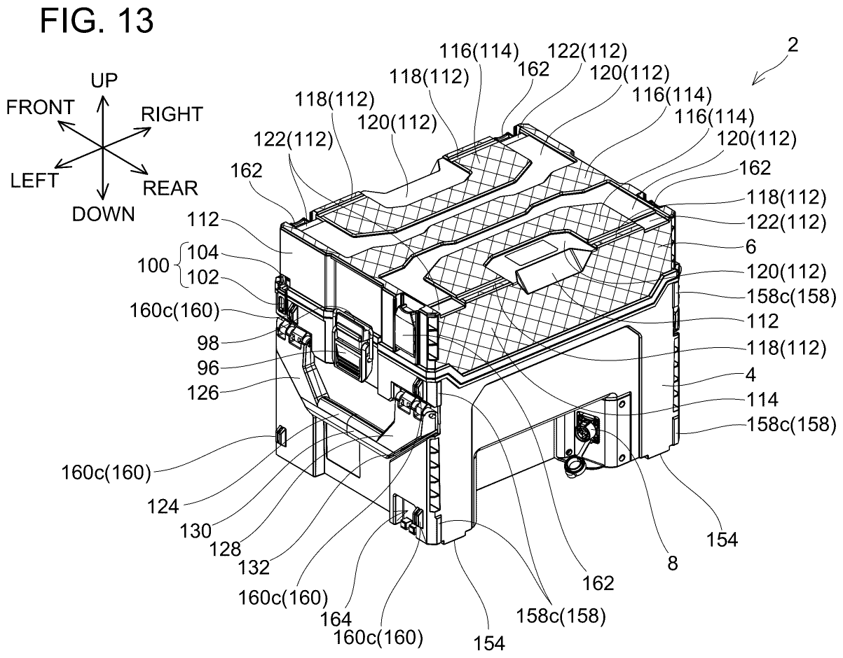

As shown in FIGS. 13 to 15, the outer surface of the lid 6 comprises a clear surface 112 and a textured surface 114. Scratches, if any, on the clear surface 112 are noticeable, but the clear surface 112 has an advantage that it is excellent in visible light permeability. By contrast, the textured surface 114 is inferior in visible light permeability to the clear surface 112 but has an advantage that scratches on the textured surface 114 are less noticeable. In FIGS. 13 to 15, the textured surface 114 is patterned with mesh to aid understanding of the drawings. However, the pattern on the textured surface 114 is not limited to mesh. The pattern on the textured surface 114 may be similar to, for example, a grain texture (creases) of leather products.

As shown in FIG. 13, the left surface of the lid 6 is almost entirely formed by the clear surface 112. The rear surface of the lid 6 is almost entirely formed by the textured surface 114. The upper surface of the lid 6 comprises a top surface 116, a first recessed surface 118 which is recessed by a first depth (e.g., 2 mm) downward from the top surface 116, a second recessed surface 120 which is recessed by a second depth (e.g., 3 mm) downward from the top surface 116, and a third recessed surface 122 which is recessed by a third depth (e.g., 4 mm) downward from the top surface 116. Within the upper surface of the lid 6, the top surface 116 is formed by the textured surface 114, whereas the first recessed surface 118, the second recessed surface 120, and the third recessed surface 122 are formed by the clear surface 112.

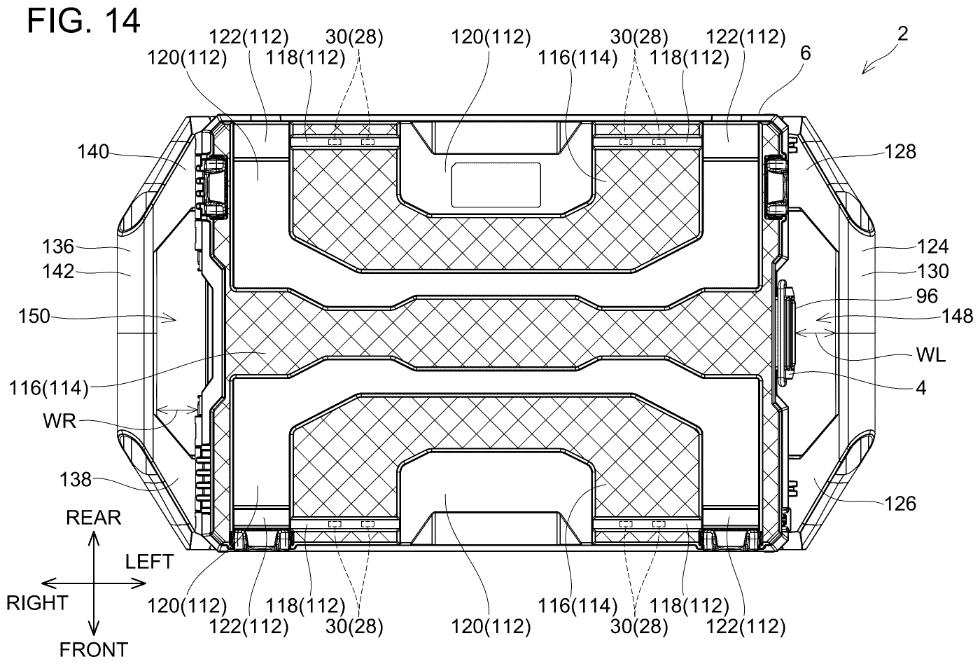

As shown in FIG. 14, in the top view of the charger 2 with the lid 6 being in the closed position, the convex portions 30 of the charging state displays 28 (that is, the position of the light emitters 184) entirely overlap the first recessed surface 118 (clear surface 112). Thus, when seeing the housing space S1 from above through the lid 6, the user can see the charging state displays 28 relatively clearly.

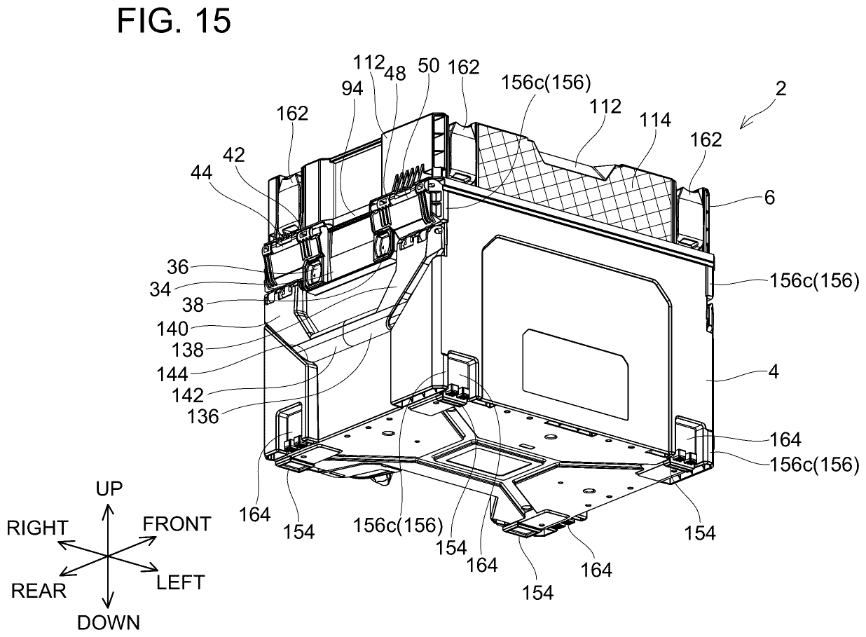

As shown in FIG. 15, the front surface of the lid 6 is almost entirely formed by the textured surface 114. The right surface of the lid 6 is almost entirely formed by the clear surface 112.

### Left Handle 124 and Right Handle 136

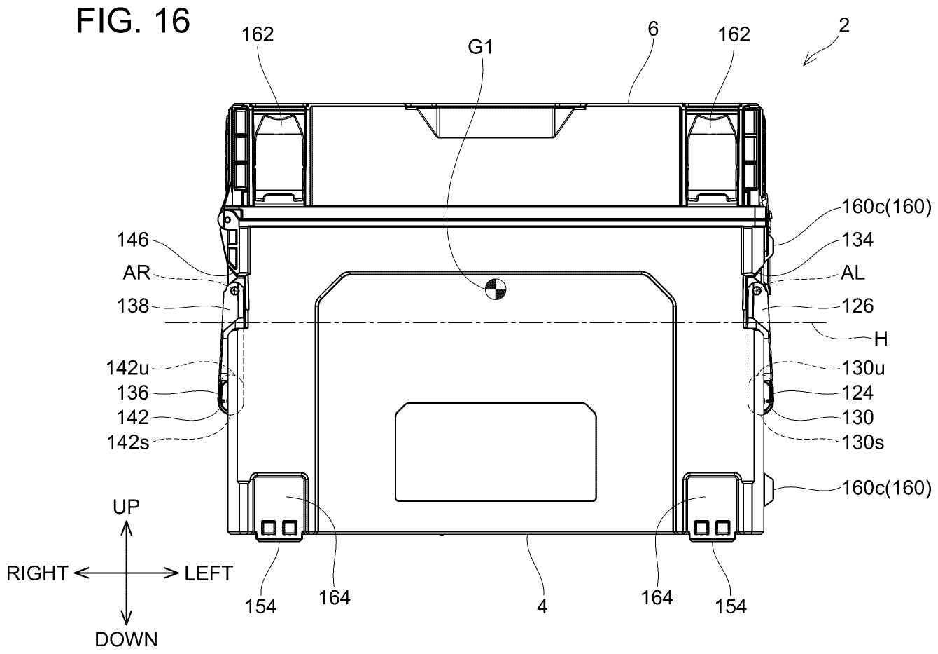

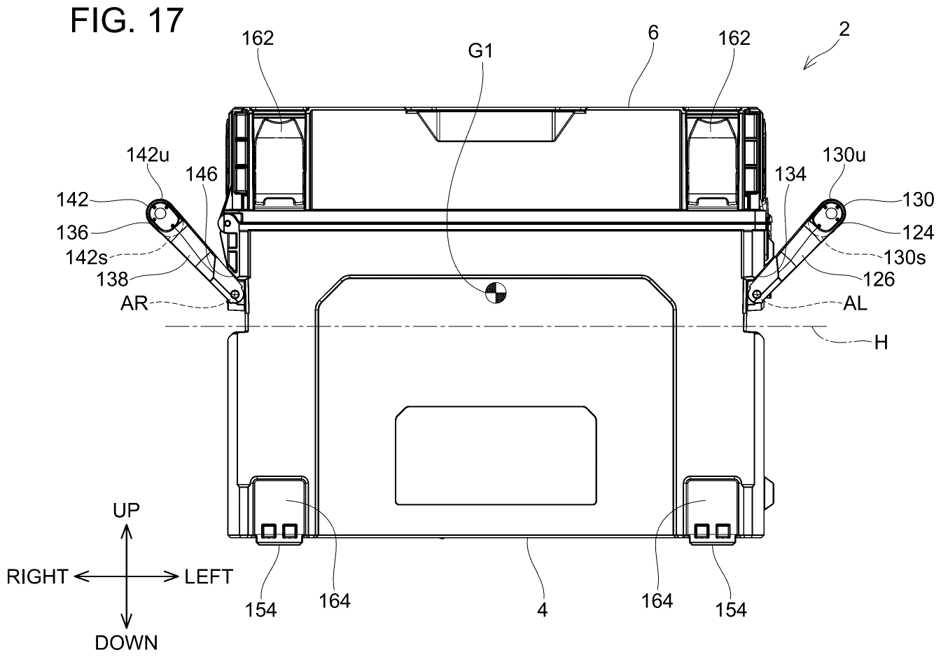

As shown in FIG. 2, a left handle 124 is disposed on the left surface of the case body 4. The weight of the left handle 124 is for example 100 grams. The left handle 124 comprises a front arm 126, a rear arm 128, and a grip 130. The grip 130 extends in the front-rear direction and connecting one end of the front arm 126 to one end of the rear arm 128. The other ends of the front arm 126 and the rear arm 128 are mounted on the case body 4 such that they are rotatable about a handle rotation axis AL (see FIGS. 16, 17) extending in the front-rear direction. Further, a handle receiving recess 132 is defined in the case body 4, and the handle receiving recess 132 is recessed rightward from the left surface of the case body 4. The handle receiving recess 132 has a shape corresponding to the shape of the left handle 124. In the state shown in FIG. 2, the left handle 124 is partially received in the handle receiving recess 132 and the right surface of the left handle 124 is in contact with the bottom surface of the handle receiving recess 132. As viewed from the front, the left handle 124 in this state cannot be further rotated clockwise. FIG. 16 shows the front view of the charger 2 in this state. In the front view, as the left handle 124 is rotated counterclockwise from the position shown in FIG. 16, the upper surface of the left handle 124 comes to contact a stopper surface 134 of the case body 4 (see FIG. 17). In the state where the upper surface of the left handle 124 is in contact with the stopper surface 134, as shown in FIG. 17, the left handle 124 cannot be further rotated counterclockwise as viewed from the front. Thus, the left handle 124 is rotatable between the position shown in FIG. 16 and the position shown in FIG. 17. During the rotation of the left handle 124, the grip 130 assumes the lowest position when the left handle 124 is in the position shown in FIG. 16 and assumes the highest position when the left handle 124 is in the position shown in FIG. 17. In the disclosure herein, the position of the left handle 124 shown in FIG. 16 is termed “left lower position” and the position of the left handle 124 shown in FIG. 17 is termed “left upper position”.

As shown in FIG. 5, a right handle 136 is disposed on the right surface of the case body 4. The weight of the right handle 136 is for example 100 grams. The right handle 136 comprises a front arm 138, a rear arm 140, and a grip 142. The grip 142 extends in the front-rear direction and connecting one end of the front arm 138 to one end of the rear arm 140. The other ends of the front arm 138 and the rear arm 140 are mounted on the case body 4 such that they are rotatable about a handle rotation axis AR (see FIGS. 16, 17) extending in the front-rear direction. Further, a handle receiving recess 144 is defined in the case body 4, and the handle receiving recess 144 is recessed leftward from the right surface of the case body 4. The handle receiving recess 144 has a shape corresponding to the shape of the right handle 136. In the state shown in FIG. 5, the right handle 136 is partially received in the handle receiving recess 144 and the left surface of the right handle 136 is in contact with the bottom surface of the handle receiving recess 144. As viewed from the front, the right handle 136 in this state cannot be further rotated counterclockwise. FIG. 16 shows the front view of the charger 2 in this state. In the front view, as the right handle 136 is rotated clockwise from the position shown in FIG. 16, the upper surface of the right handle 136 comes to contact a stopper surface 146 of the case body 4 (see FIG. 17). In the state where the upper surface of the right handle 136 is in contact with the stopper surface 146, as shown in FIG. 17, the right handle 136 cannot be further rotated clockwise as viewed from the front. Thus, the right handle 136 is rotatable between the position shown in FIG. 16 and the position shown in FIG. 17. During the rotation of the right handle 136, the grip 142 assumes the lowest position when the right handle 136 is in the position shown in FIG. 16 and assumes the highest position when the right handle 136 is in the position shown in FIG. 17. In the disclosure herein, the position of the right handle 136 shown in FIG. 16 is termed “right lower position” and the position of the right handle 136 shown in FIG. 17 is termed “right upper position”.

For example, the user can move the left handle 124 to the left upper position and the right handle 136 to the right upper position to grab the grip 130 with one hand and the grip 142 with the other hand to carry the charger 2. Further, the user can move the left handle 124 to the left lower position and the right handle 136 to the right lower position so that the left handle 124 and the right handle 136 are positioned not to interrupt the opening and closing of the lid 6 and an object to be removed from and put into the housing space S1.

As shown in FIG. 16, the handle rotation axis AL of the left handle 124 is positioned above a horizontal bisection plane H that bisects the charger 2 in the up-down direction and above a center of gravity G1 of the charger 2. When the left handle 124 is in the left lower position, an upper end 130u of the grip 130 is positioned below the handle rotation axis AL, below the horizontal bisection plane H, and below the opening edge 106 of the case body 4 (i.e., the upper end of the case body 4) (see FIG. 1). Similarly, the handle rotation axis AR of the right handle 136 is positioned above the horizontal bisection plane H and above a center of gravity G1 of the charger 2. When the right handle 136 is in the right lower position, an upper end 142u of the grip 142 is positioned below the handle rotation axis AR, below the horizontal bisection plane H, and below the opening edge 106 of the case body 4 (i.e., the upper end of the case body 4) (see FIG. 1). Further, the upper end 130u of the grip 130 and the upper end 142u of the grip 142 are positioned below the center of gravity G1 of the charger 2. In this embodiment, the center of gravity G1 of the charger 2 means the center of gravity of the charger 2 with the battery packs B attached in all of the eight battery receptacles 18 (see FIG. 3).

As shown in FIG. 17, when the left handle 124 is in the left upper position, a lower end 130s of the grip 130 is positioned above the handle rotation axis AL and above the horizontal bisection plane H, and the upper end 130u of the grip 130 is positioned above the opening edge 106 of the case body 4 (i.e., the upper end of the case body 4) (see FIG. 1). Similarly, when the right handle 136 is in the right upper position, a lower end 142s of the grip 142 is positioned above the handle rotation axis AR and above the horizontal bisection plane H, and the upper end 142u of the grip 142 is positioned above the opening edge 106 of the case body 4 (i.e., the upper end of the case body 4) (see FIG. 1). Further, the lower end 130s of the grip 130 and the lower end 142s of the grip 142 are positioned above the center of gravity G1 of the charger 2. In this embodiment, the center of gravity G1 of the charger 2 is constant in position regardless of the positions of the left handle 124 and the right handle 136. This is because changes in the positions of the left handle 124 and the right handle 136 do not substantially affect the position of the center of gravity G1 of the charger 2 since the weights of the left handle 124 and the right handle 136 are much lighter than the weight of the charger 2.

As shown in FIG. 14, when the left handle 124 is in the left upper position, a clearance 148 is defined between the outer surface of the grip 130 and the outer surfaces of the case body 4 and the lid 6. A width WL of the clearance 148 in the left-right direction is for example in a range from 25 mm to 55 mm, and in this embodiment, it is 28 mm. The width WL of the clearance 148 can be rephrased as the distance from the outer surface of the grip 130 to the outer surfaces of the case body 4 and the lid 6. Similarly, when the right handle 136 is in the right upper position, a clearance 150 is defined between the outer surface of the grip 142 and the outer surfaces of the case body 4 and the lid 6. A width WR of the clearance 150 in the left-right direction is for example in a range from 25 mm to 55 mm, and in this embodiment, it is 29 mm. The width WR of the clearance 150 can be rephrased as the distance from the outer surface of the grip 142 to the outer surfaces of the case body 4 and the lid 6

### Feet 154, 156, 158, 160

As shown in FIGS. 2 and 5, feet 154, 156, 158, 160 are located on the case body 4, and they project from the outer surface of the case body 4. The feet 154, 156, 158, 160 comprise a lower foot 154 located on the lower surface of the case body 4, a front foot 156 located on the front surface of the case body 4, a rear foot 158 located on the rear surface of the case body 4, and a left foot 160 located on the left surface of the case body 4. The lower foot 154 contacts the placement surface P when the charger 2 is placed on the placement surface P with the down direction of the charger 2 being coincident with the vertically downward direction. The front foot 156 contacts the placement surface P when the charger 2 is placed on the placement surface P with the front direction of the charger 2 being coincident with the vertically downward direction. The rear foot 158 contacts the placement surface P when the charger 2 is placed on the placement surface P with the rear direction of the charger 2 being coincident with the vertically downward direction. The left foot 160 contacts the placement surface P when the charger 2 is placed on the placement surface P with the left direction of the charger 2 being coincide with the vertically downward direction.

Among the feet 154, 156, 158, 160, the front foot 156, the rear foot 158, and the left foot 160 are coated with a rubber material (e.g., EPDM (ethylene propylene diene monomer rubber)). That is, the rubber material is used for a front contact portion 156c of the front foot 156 that is configured to contact the placement surface P, a rear contact portion 158c of the rear foot 158 that is configured to contact the placement surface P, and a left contact portion 160c of the left foot 160 that is configured to contact the placement surface P.

For example, when the charger 2 is on a stand or a shelf (i.e., somewhere above the ground) with the housing space S1 directed in the vertically upward direction, the user may have difficulty in accessing the housing space S1. However, as shown in FIG. 10, the charger 2 can be placed on the placement surface P with the rear foot 158 (see FIG. 2) being in contact with the placement surface P. Or, as shown in FIG. 11, the charger 2 can be placed on the placement surface P with the left foot 160 (see FIG. 2) being in contact with the placement surface P. Or, the charger 2 can be placed on the placement surface P with the front foot 156 being in contact with the placement surface P, although this is not shown. Orienting the charger 2 in any of the above allows the housing space S1 to direct in the horizontal direction and thus allows the user to easily access the housing space S1.

As shown in FIG. 16, the left end of the left handle 124 in the left lower position is positioned rightward of the left end of the left foot 160 (the left contact portion 160c). Thus, when the left foot 160 is in contact with the placement surface P, as shown in FIG. 11, with the left handle 124 being in the left lower position, the vertically lower end of the left handle 124 (the left end of the left handle 124 in FIG. 16) is positioned vertically above the vertically lower end of the left foot 160 (the left end of the left foot 160 in FIG. 16). This prevents the left handle 124 from contacting the placement surface P and thus prevents dirt (e.g., sand) on the placement surface P from adhering to the left handle 124.

### Multiple Connection of Chargers 2

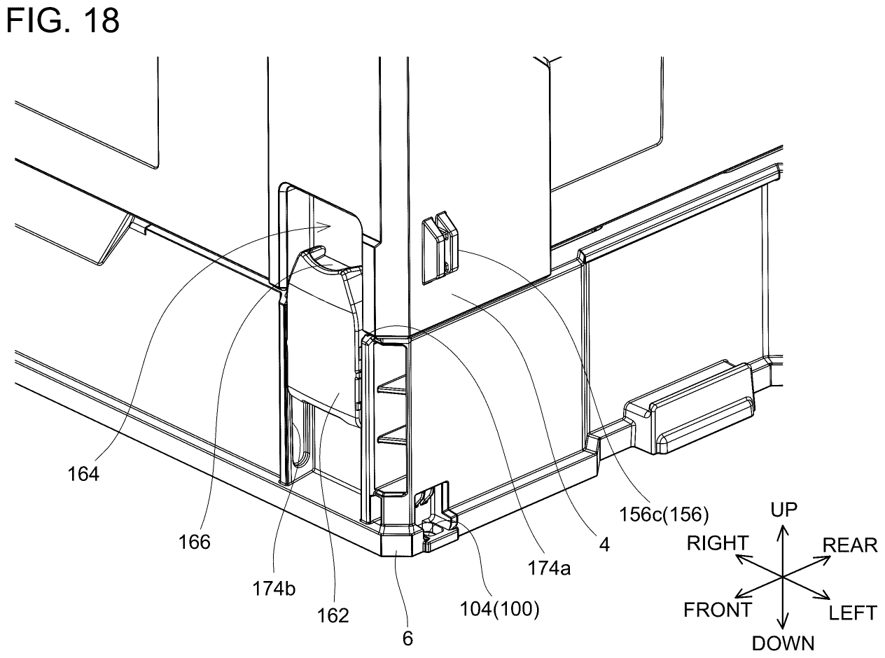

As shown in FIGS. 2 and 5, four engagement members 162 are located on the lid 6. Further, four engagement receivers 164 corresponding to the four engagement members 162 are located in a lower portion of the case body 4. As shown in FIG. 18, when the case body 4 of a charger 2 is on the lid 6 of another charger 2, the engagement receivers of the case body 4 are in engagement with the engagement members 162 of the lid 6. Specifically, when two chargers 2 are stacked on top of each other, the engagement members 162 of one charger 2 are engaged with the engagement receivers 164 of the other charger 2. The two chargers 2 can be connected to each other in this way.

Hereinafter, the engagement of the engagement members 162 with the engagement receivers 164 is described focusing on one engagement member 162 located on a left portion of the front surface of a lid 6 of a charger 2 (see FIG. 5) and one engagement receiver 164 located in a left portion of the front surface of a case body 4 of another charger 2 (see FIG. 5).

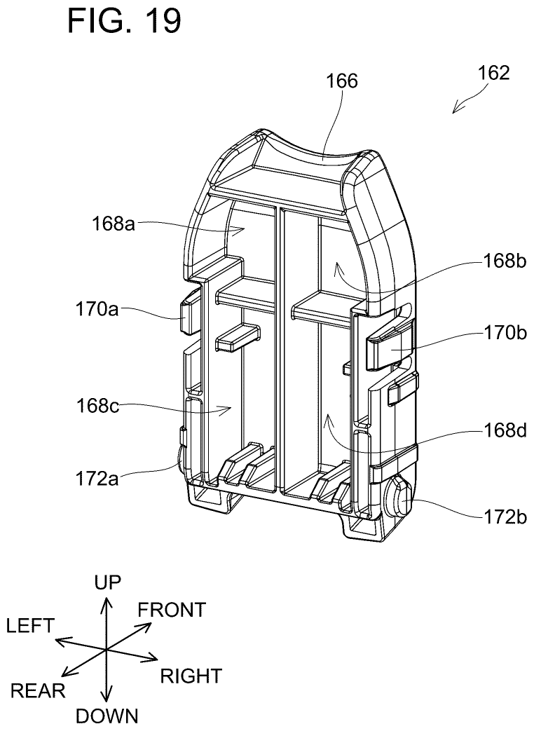

As shown in FIG. 19, the engagement member 162 comprises a manipulatable portion 166; cavities 168a, 168b, 168c, 168d; snaps 170a, 170b; and shafts 172a, 172b. The manipulatable portion 166 is located in an upper portion of the engagement member 162 and has a shape manipulatable by the user. The cavities 168a, 168b, 168c, 168d are recessed forward from the rear surface of the engagement member 162. The cavities 168a, 168b are adjacent to each other in the left-right direction and located below the manipulatable portion 166. The cavities 168c, 168d are adjacent to each other in the left-right direction and located below the cavities 168a, 168b. The snap 170a is located on a center portion of the left surface of the engagement member 162 and is elastically deformable in the left-right direction. The snap 170b is located on a center portion of the right surface of the engagement member 162 and is elastically deformable in the left-right direction. The shaft 172a is located on the left surface of the engagement member 162 and below the snap 170a, and projects leftward from the left surface of the engagement member 162. The shaft 172b is located on the right surface of the engagement member 162 and below the snap 170b, and projects rightward from the right surface of the engagement member 162.

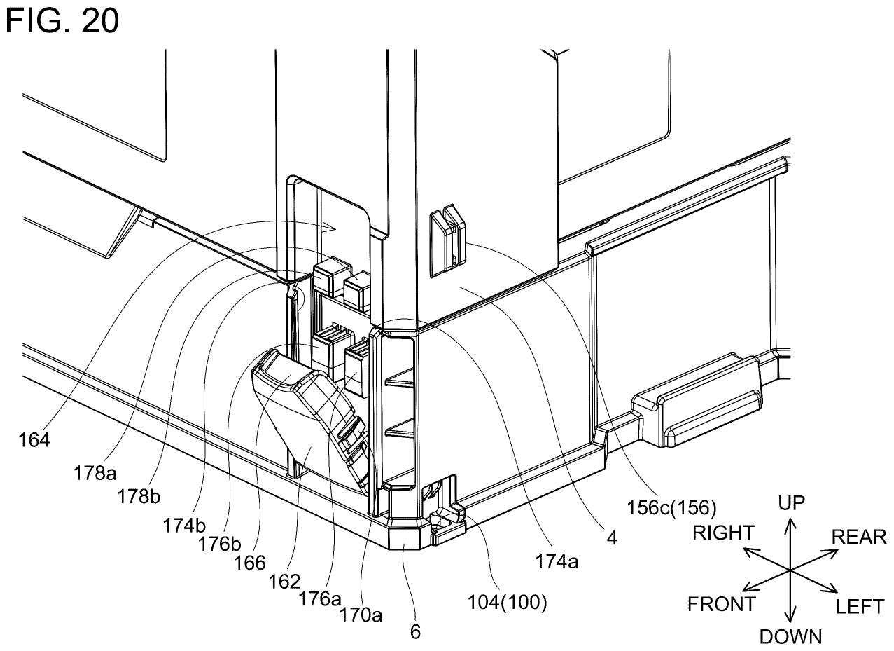

As shown in FIG. 20, grooves 174a, 174b are defined in the lid 6, and the grooves 174a, 174b are configured to receive the shafts 172a, 172b of the engagement member 162 (see FIG. 19) such that the shafts 172a, 172b are movable in the up-down direction and rotatable in their circumferential direction. Further, lid-side projections 176a, 176b are located on the lid 6, and the lid-side projections 176a, 176b are configured to be insertable into the cavities 168a, 168b, 168c, 168d of the engagement member 162. When the engagement member 162 is in its normal position (the position shown in FIG. 5), the lid-side projections 176a, 176b are in the cavities 168a, 168b (see FIG. 19). When the lid-side projections 176a, 176b are in the cavities 168a, 168b, the engagement member 162 is prohibited from moving in the up-down direction relative to the lid 6. Further, when the engagement member 162 is in the normal position (the position shown in FIG. 5), the snaps 170a, 170b of the engagement member 162 are engaged with the grooves 174a, 174b in a snap-fit manner. When a forward pulling force is applied to the manipulatable portion 166 of the engagement member 162 in the normal position, the snaps 170a, 170b are disengaged from the grooves 174a, 174b and the engagement member 162 is rotated about the shafts 172a, 172b. Thereby, the lid-side projections 176a, 176b are pulled out from the cavities 168a, 168b, as shown in FIG. 20, and the engagement member 162 is permitted to move in the up-down direction relative to the lid 6.

When the case body 4 is on the lid 6, the engagement receiver 164 is positioned above the engagement member 162. Case-side projections 178a, 178b are located on the engagement receiver 164, and the case-side projections 178a, 178b are configured to be insertable into the cavities 168a, 168b. When the case body 4 is on the lid 6, the case-side projections 178a, 178b can be aligned with the cavities 168a, 168b and the lid-side projections 176a, 176b can be aligned with the cavities 168c, 168d by moving the engagement member 162 in the up-down direction. When such moved engagement member 162 is pushed rearward, the case-side projections 178a, 178b are inserted into the cavities 168a, 168b, the lid-side projections 176a, 176b are inserted into the cavities 168c, 168d, and the snaps 170a, 170b engage with the grooves 174a, 174b in a snap-fit manner. As a result, as shown in FIG. 18, the engagement member 162 is engaged with the engagement receiver 164. When the manipulatable portion 166 is pulled forward, the snap-fit engagement of the snaps 170a, 170b with the grooves 174a, 174b is disengaged, the engagement member 162 is rotated about the shafts 172a, 172b, and the case-side projections 178a, 178b and the lid-side projections 176a, 176b are pulled out from the cavities 168a, 168b, 168c, 168d. The engagement member 162 is thereby disengaged from the engagement receiver 164.

### Second Embodiment: Charger 202

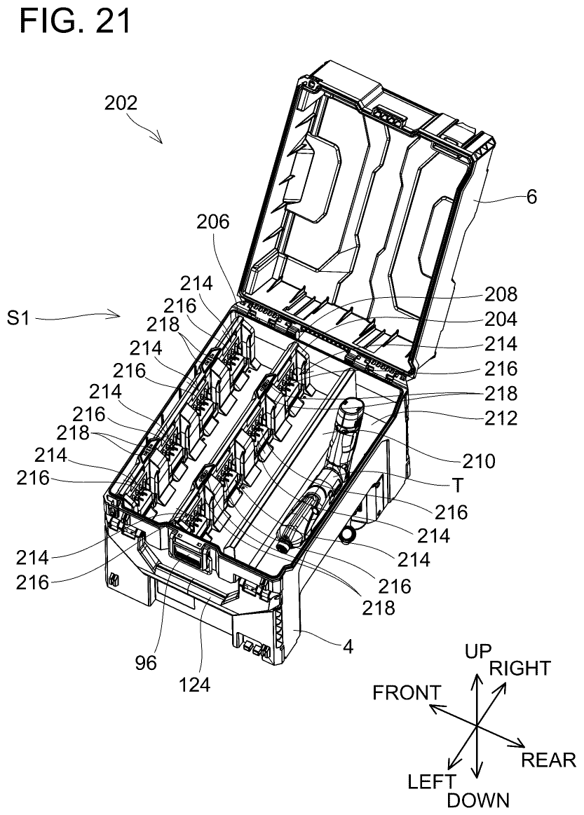

A charger 202 shown in FIG. 21 is different from the charger 2 according to the first embodiment (see FIG. 1) in that it includes a tray member 204 instead of the tray member 10 (see FIG. 4). The other components of the charger 202 are substantially the same as those of the charger 2 according to the first embodiment. The following description focuses on the tray member 204.

The tray member 204 comprises a first wall 206, a second wall 208, a third wall 210, and a bottom wall 212. The first wall 206 extends in the up-down direction and the left-right direction along the front wall of the case body 4. The second wall 208 is located rearward of the first wall 206 and extends in the up-down direction and the left-right direction. The third wall 210 is located rearward of the second wall 208 and extends in the up-down direction and left-right direction. As with the bottom wall 16 of the tray member 10 in the first embodiment (see FIG. 4), the bottom wall 212 is separated from the bottom wall of the case body 4 and extends in the front-rear direction and the left-right direction. Eight battery receptacles 214, eight connection terminals 216, and eight charging state displays 218 are located on the tray member 204. Four battery receptacles 214 are located on the rear surface of the first wall 206 and the other four battery receptacles 214 are located on the rear surface of the second wall 208. Each connection terminal 216 and each charging state display 218 are assigned to corresponding one of the battery receptacles 214. Configurations of the battery receptacles 214, the connection terminals 216, and the charging state displays 218 are substantially the same as those of the battery receptacles 18, the connection terminals 26, and the charging state displays 28 in the first embodiment (see FIG. 3), and thus detailed descriptions for them are omitted here. A part of the housing space S1 that is located rearward of the third wall 210 is a substantially cuboid space. This space can house, for example, a manual tool, a power tool, and/or an accessary of a power tool. In the example shown in FIG. 21, a power tool Tis housed in the part of the housing space S1 located rearward of the third wall 210.

### Variants of First and Second Embodiments

The charger 2 (the charger 202) may be configured to supply electric power supplied from the battery packs B to an external via the external terminal 8. That is, the charger 2 (the charger 202) may function as a power supply device configured to supply electric power to an external.

The charger 2 (the charger 202) may comprise an operation unit configured to perform a predetermined operation (e.g., heating, retaining heat, cooling) using electric power supplied from the battery packs B. For example, the charger 2 (the charger 202) may function as a microwave, a warmer, or a refrigerator.

The charger 2 (the charger 202) may not comprise the external terminal 8, the tray member 10 (the tray member 204), nor the control board 32. In this case, the charger 2 (the charger 202) may function as a carrying case used to carry an object.

The battery receptacles 18 may be located on the outer surface of the case body 4. In this case, the battery packs B may be detachably attached to the outer surface of the case body 4.

The arrangement and/or orientation of the battery receptacles 18 (the battery receptacles 214) on the tray member 10 (the tray member 204) may be varied. In this case, the directions in which the battery packs B are slid for attachment to and detachment from the battery receptacles 18 (the battery receptacles 214) may be directions inclined to the up-down direction (e.g., the front-rear direction, the left-right direction).

The case body 4 may have a shape different from the substantially cuboid shape (e.g., a substantially cylindrical shape, a substantially hexagonal-column shape)

The case body 4 and the lid 6 may be slidably coupled to each other. For example, a long hole extending in the left-right direction may be defined in the lid 6, and the first coupling pin 40 and the second coupling pin 46 may be inserted in the long hole. Within the long hole, the first coupling pin 40 and the second coupling pin 46 are slidable in the left-right direction, so that the lid 6 is slidable in the left-right direction relative to the case body 4. In this case as well, the lid 6 may be disengaged from the case body 4 by detaching the first coupling pin 40 and the second coupling pin 46 from the case body 4.

(See FIG. 6.) The finger pad 60 and/or the wall 62 may be aligned with the first coupling pin 40 in the front-rear direction (the axial direction of the first coupling pin 40). The finger pad 74 and/or the wall 76 may be aligned with the second coupling pin 46 in the front-rear direction (the axial direction of the second coupling pin 46).

(See FIG. 6.) The guide 80 and the engagement pieces 86, 90 may be located on the lid 6 instead of the case body 4. That is, the first coupling member 36 (the second coupling member 38) may be attached to the lid 6 instead of the case body 4. In this case, the blocking projection 94 may be located on the case body 4.

(See FIG. 6.) The guide 80 and the engagement pieces 86, 90 may be located on the inner surface of the case body 4 (inside of the housing space S1) instead of the outer surface of the case body 4. That is, the first coupling member 36 (the second coupling member 38) may be attached to the inner surface of the case body 4 (inside of the housing space S1) instead of the outer surface of the case body 4.

(See FIG. 5.) The lid 6 may not comprise the blocking projection 94. In this case, the first coupling member 36 (the second coupling member 38) may be permitted to move between the first coupling position (the second coupling position) and the first decoupled position (the second decoupling position) regardless of the opening degree of the lid 6.

(See FIG. 6.) The first coupling member 36 (the second coupling member 38) may not comprise the engagement rib 64 (the engagement rib 78). The first coupling member 36 (the second coupling member 38) may not comprise the finger pad 60 (the finger pad 74). The first coupling member 36 (the second coupling member 38) may not comprise the wall 62 (the wall 76).

(See FIGS. 2 and 5.) The positional change of the grip 130 of the left handle 124 (the grip 142 of the right handle 136) may not be implemented by rotatably mounting the left handle 124 (the right handle 136) on the case body 4 and may be implemented by other means. For example, the positional change of the grip 130 of the left handle 124 (the grip 142 of the right handle 136) may be implemented by slidably mounting the left handle 124 (the right handle 136) on the case body 4. Alternatively, the positional change of the grip 130 of the left handle 124 (the grip 142 of the right handle 136) may be implemented by the arms 126, 128 of the left handle 124 (the arms 138, 140 of the right handle 136) including an extendable mechanism (e.g., a telescopic mechanism).

(See FIGS. 16 and 17.) The arrangement and/or shape of the left handle 124 may be varied. In this case, the handle rotation axis AL of the left handle 124 may be positioned below the horizontal bisection plane H. When the left handle 124 is in the left upper position, the lower end 130s of the grip 130 may be positioned below the handle rotation axis AL. When the left handle 124 is in the left upper position, the lower end 130s of the grip 130 may be positioned below the horizontal bisection plane H. When the left handle 124 is in the left upper position, the upper end 130u of the grip 130 may be positioned below the opening edge 106 of the case body 4 (i.e., the upper end of the case body 4) (see FIG. 1). The width WL of the clearance 148 may be smaller than 25 mm or larger than 55 mm.

(See FIGS. 16 and 17.) The arrangement and/or shape of the right handle 136 may be varied. In this case, the handle rotation axis AR of the right handle 136 may be positioned below the horizontal bisection plane H. When the right handle 136 is in the right upper position, the lower end 142s of the grip 142 may be positioned below the handle rotation axis AR. When the right handle 136 is in the right upper position, the lower end 142s of the grip 142 may be positioned below the horizontal bisection plane H. When the right handle 136 is in the right upper position, the upper end 142u of the grip 142 may be positioned below the opening edge 106 of the case body 4 (i.e., the upper end of the case body 4) (see FIG. 1). The width WR of the clearance 150 may be smaller than 25 mm or larger than 55 mm.

When the left handle 124 is in the left upper position and the right handle 136 is in the right upper position, the lower end 130s of the grip 130 and the lower end 142s of the grip 142 both may be positioned below the center of gravity G1 of the charger 2 (the charger 202).

(See FIGS. 2 and 5.) The charger 2 (the charger 202) may not comprise the front foot 156 and/or the rear foot 158.

(See FIGS. 2 and 5.) The front foot 156, the rear foot 158, and/or the left foot 160 may not be coated with the rubber material. That is, the same material as that of the case body 4 (e.g., PC+ABS) may be used for the front foot 156, the rear foot 158, and/or the left foot 160.

(See FIGS. 2 and 5.) The front foot 156, the rear foot 158, and/or the left foot 160 may be different from those described in connection with the first and second embodiments. For example, the front foot 156, the rear foot 158, and/or the left foot 160 may be sheets that are constituted of a rubber material (i.e., rubber sheets) and attached to the outer surface of the case body 4. Alternatively, the front foot 156, the rear foot 158, and/or the left foot 160 may be blocks that are constituted of a rubber material and inserted to the case body 4. Alternatively, the front foot 156, the rear foot 158, and/or the left foot 160 may be blocks that are constituted of a rubber material and screwed to the case body 4.

(See FIG. 5.) The charger 2 (the charger 202) may not comprise the right handle 136. In this case, the user can carry the charger 2 (the charger 202) grasping the left handle 124 with one hand (or both hands).

### Features of First and Second Embodiments

In one or more embodiments, the charger 2, 202 (an example of electrical device) comprises: the case body 4 defining the housing space S1; the battery receptacles 18, 214 disposed on the case body 4, wherein the battery packs B used as power supplies for power tools are detachably attached to the battery receptacles 18, 214; the external terminal 8 disposed on the case body 4 and configured to be electrically connected to the battery packs B via the battery receptacles 18, 214; the lid 6 configured to be movable relative to the case body 4 between the open position where the lid 6 opens the housing space S1 and the closed position where the lid 6 closes the housing space S1; and the coupling mechanism 34 configured to be switchable between the coupling state in which the coupling mechanism 34 couples the case body 4 and the lid 6 to each other and the decoupled state in which the coupling mechanism 34 decouples the case body 4 and the lid 6 from each other.

The configuration above allows the user to decouple the lid 6 from the case body 4 by switching the coupling mechanism 34 to the decoupled state. Thus, the user can remove the lid 6 from the case body 4 if the lid 6 is interfering. The configuration above thus can reduce the inconvenience for the user in using the electrical device.

In one or more embodiments, when the lid 6 is in the closed position, switching of the coupling mechanism 34 from the coupling state to the decoupled state is prohibited. When the lid 6 is in the open position, the switching of the coupling mechanism 34 from the coupling state to the decoupled state is permitted.

For example, from a perspective of safety, the user may wish to prevent decoupling of the lid 6 from the case body 4 when the posture of the charger 2, 202 is unstable (e.g., when the user is carrying the charger 2, 202). Normally, the lid 6 is expected to be in the closed position when the posture of the charger 2, 202 is unstable. According to the configuration above, the lid 6 is prohibited from being decoupled from the case body 4 when the lid 6 is in the closed position. The lid 6 is permitted to be decoupled from the case body 4 when the lid 6 is in the open position. Thus, the configuration above prevents the lid 6 from being decoupled from the case body 4 when the posture of the charger 2, 202 is unstable, and thus improves the safety of the charger 2, 202.

In one or more embodiments, the coupling mechanism 34 comprises the first coupling member 36 (the second coupling member 38) configured to be movable between the first coupling position (the second coupling position) in which the coupling members 36, 38 couples the case body 4 and the lid 6 to each other and the first decoupled position (the second decoupled position) in which the coupling members 36, 38 decouples the case body 4 and the lid 6 from each other. The coupling state is the state in which the first coupling member 36 (the second coupling member 38) is in the first coupling position (the second coupling position). The decoupled state is the state in which the first coupling member 36 (the second coupling member 38) is in the first decoupled position (the second decoupled position).

The configuration above allows the user to switch the coupling mechanism 34 between the coupling state and the decoupled state by changing the position of the first coupling member 36 (the second coupling member 38) between the first coupling position (the second coupling position) and the first decoupled position (the second decoupled position). This allows for a simple configuration of the coupling mechanism 34.

In one or more embodiments, the first coupling member 36 (the second coupling member 38) is attached on the outer surface of the case body 4 (an example of the outer surface of one of the case body and the lid).

According to the configuration above, the first coupling member 36 (the second coupling member 38) is disposed at a place the user can easily access.

In one or more embodiments, the first coupling member 36 (the second coupling member 38) comprises the engagement rib 64 (the engagement rib 78) (an example of engagement portion) configured to engage with the case body 4 (an example of one of the case body and the lid) when the first coupling member 36 (the second coupling member 38) is in the first coupling position (the second coupling position).

According to the configuration above, the user needs to disengage the engagement rib 64 (the engagement rib 78) from the case body 4 before moving the first coupling member 36 (the second coupling member 38) from the first coupling position (the second coupling position) to the first decoupled position (the second decoupled position). This prevents the first coupling member 36 (the second coupling member 38) from moving from the first coupling position (the second coupling position) to the first decoupled position (the second decoupled position) when the user does not intend to do so (i.e., decoupling of the lid 6 from the case body 4 can be suppressed from occurring unexpectedly).

In one or more embodiments, the lid 6 (an example of one of the case body and the lid) comprises the blocking projection 94 (an example of blocking portion) configured to block movement of the first coupling member 36 (the second coupling member 38) from the first coupling position (the second coupling position) to the first decoupled position (the second decoupled position) when the lid 6 is in the closed position. The blocking projection 94 does not block the movement of the first coupling member 36 (the second coupling member 38) from the first coupling position (the second coupling position) to the first decoupled position (the second decoupled position) when the lid 6 is in the open position.

For example, from the perspective of safety, the user may wish to prevent decoupling of the lid 6 from the case body 4 when the posture of the charger 2, 202 is unstable (e.g., when the user is carrying the charger 2, 202). Normally, the lid 6 is expected to be in the closed position when the posture of the charger 2, 202 is unstable. According to the configuration above, the lid 6 is prevented from being decoupled from the case body 4 when the lid 6 is in the closed position since the blocking projection 94 blocks the movement of the first coupling member 36 (the second coupling member 38) from the first coupling position (the second coupling position) to the first decoupled position (the second decoupled position). Thus, the configuration above prevents the lid 6 from being decoupled from the case body 4 when the posture of the charger 2, 202 is unstable, and thus improves the safety of the charger 2, 202.

In one or more embodiments, the first coupling member 36 (the second coupling member 38) comprises: the first coupling pin 40 (the second coupling pin 46) configured to be inserted in both the first case-side tube 42 (the second case-side tube 48) (an example of case-side insertion element) located on the case body 4 and the first lid-side tube 44 (the second lid-side tube 50) (an example of lid-side insertion element) located on the lid 6 to couple the case body 4 and the lid 6 to each other such that the case body 4 and the lid 6 are rotatable relative to each other; and the first manipulatable portion 52 (the second manipulatable portion 66) fixed to the first coupling pin 40 (the second coupling pin 46) and configured to be manipulated by the user. The first coupling position (the second coupling position) is the position in which the first coupling pin 40 (the second coupling pin 46) is inserted in both the first case-side tube 42 (the second case-side tube 48) and the first lid-side tube 44 (the second lid-side tube 50). The first decoupled position (the second decoupled position) is the position in which the first coupling pin 40 (the second coupling pin 46) is out of the first lid-side tube 44 (the second lid-side tube 50).

The configuration above allows the user to switch the coupling mechanism 34 between the coupling state and the decoupled state by sliding the first coupling member 36 (the second coupling member 38) in the axial direction of the first coupling pin 40 (the second coupling pin 46) to insert/pull the first coupling pin 40 (the second coupling pin 46) into/out of the first case-side tube 42 (the second case-side tube 48) and the first lid-side tube 44 (the second lid-side tube 50. This allows for a simple configuration of the coupling mechanism 34.

In one or more embodiments, the first manipulatable portion 52 (the second manipulatable portion 66) comprises the finger pad 60 (the finger pad 74) configured for the user to put a finger on. The finger pad 60 (the finger pad 74) is offset from the first coupling pin 40 (the second coupling pin 46) in the radial direction of the first coupling pin 40 (the second coupling pin 46).

The configuration above allows the user to move the first coupling member 36 (the second coupling member 38) with his/her finger on the finger pad 60 (the finger pad 74) of the first coupling member 36 (the second coupling member 38) without using a special tool. However, if the finger pad 60 (the finger pad 74) and the first coupling pin 40 (the second coupling pin 46) are aligned in the axial direction of the first coupling pin 40 (the second coupling pin 46), this may result in an increased size of the first coupling member 36 (the second coupling member 38) in the axial direction of the first coupling pin 40 (the second coupling pin 46). In the configuration above, the finger pad 60 (the finger pad 74) is offset from the first coupling pin 40 (the second coupling pin 46) in the radial direction of the first coupling pin 40 (the second coupling pin 46), and thus the finger pad 60 (the finger pad 74) and the first coupling pin 40 (the second coupling pin 46) are not aligned in the axial direction of the first coupling pin 40 (the second coupling pin 46). This allows for a reduction in the size of the first coupling member 36 (the second coupling member 38) in the axial direction of the first coupling pin 40 (the second coupling pin 46).

In one or more embodiments, the first manipulatable portion 52 (the second manipulatable portion 66) comprises the wall 62 (the wall 76) extending in the direction perpendicular to the axial direction of the first coupling pin 40 (the second coupling pin 46) and configured to allow a plate element to contact thereto. The wall 62 (the wall 76) is offset from the first coupling pin 40 (the second coupling pin 46) in the radial direction of the first coupling pin 40 (the second coupling pin 46).

The configuration above allows the user to apply a force against the first coupling member 36 (the second coupling member 38) in the axial direction of the first coupling pin 40 (the second coupling pin 46) via a plate element (e.g., a coin, a flathead screwdriver, etc.) by bringing the plate element into contact with the wall 62 (the wall 76) of the first coupling member 36 (the second coupling member 38). However, if the wall 62 (the wall 76) and the first coupling pin 40 (the second coupling pin 46) are aligned in the axial direction of the first coupling pin 40 (the second coupling pin 46), this may result in an increased size of the first coupling member 36 (the second coupling member 38) in the axial direction of the first coupling pin 40 (the second coupling pin 46). In the configuration above, the wall 62 (the wall 76) is offset from the first coupling pin 40 (the second coupling pin 46) in the radial direction of the first coupling pin 40 (the second coupling pin 46), and thus the wall 62 (the wall 76) and the first coupling pin 40 (the second coupling pin 46) are not aligned in the axial direction of the first coupling pin 40 (the second coupling pin 46). This allows for a reduction in the size of the first coupling member 36 (the second coupling member 38) in the axial direction of the first coupling pin 40 (the second coupling pin 46).

In one or more embodiments, the battery receptacles 18, 214 are disposed within the housing space S1.

If the battery receptacles 18, 214 are disposed outside the housing space S1 (e.g., on the outer surface of the case body 4), the battery packs B attached on the battery receptacles 18, 214 are exposed to the outside of the housing space S1. In this case, the battery packs B may collide with an object (e.g., a tool, the ground, a wall) and be damaged. According to the configuration above, the battery receptacles 18, 214 are disposed within the housing space S1, and thus the battery packs B attached on the battery receptacles 18, 214 are not exposed to the outside of the housing space S1. The battery packs B are thus prevented from colliding with an object and being damaged.

In one or more embodiments, the battery packs B are attached to the battery receptacles 18, 214 by being slid along a predetermined sliding direction (up-down direction) relative to the battery receptacles 18, 214. The sliding direction (up-down direction) is along the direction in which the housing space S1 is opened (upward).

The configuration above allows the user to easily attach/detach the battery packs B to/from the battery receptacles 18, 214.

In one or more embodiments, the charger 2, 202 (an example of carrying case) is configured to allow the user to carry the battery packs B used as power supplies for power tools. The charger 2, 202 comprises: the case body 4 defining the housing space S1; the lid 6 configured to be movable relative to the case body 4 between the open position in which the lid 6 opens the housing space S1 and the closed position in which the lid 6 closes the housing space S1; and the coupling mechanism 34 configured to be switchable between the coupling state in which the coupling mechanism 34 couples the case body 4 and the lid 6 to each other and the decoupled state in which the coupling mechanism 34 decouples the case body 4 and the lid 6 from each other.

The configuration above allows the user to decouple the lid 6 from the case body 4 by switching the coupling mechanism 34 to the decoupled state. Thus, the user can remove the lid 6 from the case body 4 if the lid 6 is interfering. The configuration above thus can reduce the inconvenience for the user in using the electrical device.

In one or more embodiments, the charger 2, 202 further comprises the battery receptacles 18, 241 disposed on the case body 4, wherein the battery packs B are detachably attached to the battery receptacles 18, 214.

The configuration above allows the battery packs B to be positioned relative to the charger 2, 202 by attaching the battery packs B to the battery receptacles 18, 214.

### Third Embodiment: Charger 302

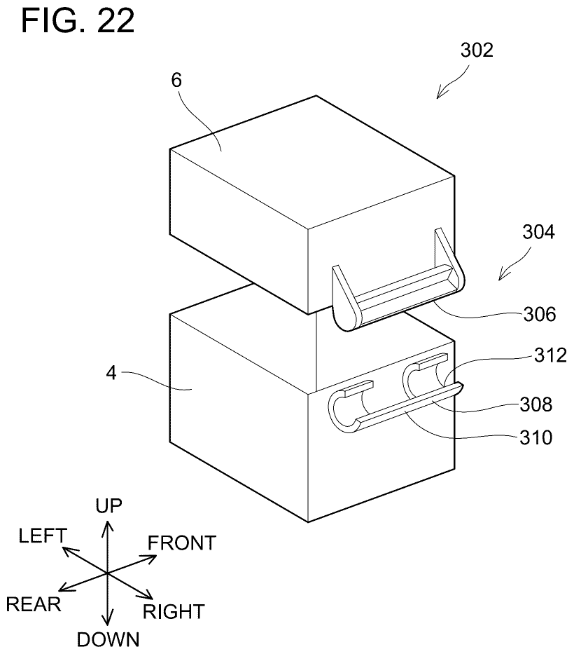

As shown in FIG. 22, a charger 302 is different from the charger 2 according to the first embodiment in that the former comprises a coupling mechanism 304 instead of the coupling mechanism 34 (see FIG. 6). The charger 302 is substantially identical to the charger 2 according to the first embodiment, except for the difference above. The following description focuses on the coupling mechanism 304.

The coupling mechanism 304 comprises a shaft 306 on the lid 6 and a shaft holder 308 on the case body 4. The shaft 306 extends in the front-rear direction. The shaft 306 has a cylindrical shape having a notch extending over the overall length of the shaft 306 in the side surface of the cylinder. The shaft holder 308 comprises a tube 310 configured to receive the shaft 306 such that the shaft 306 is rotatable therein and a shaft insertion passage 312 communicating the inside of the tube 310 with the outside of the tube 310 in a radial direction of the shaft holder 308.

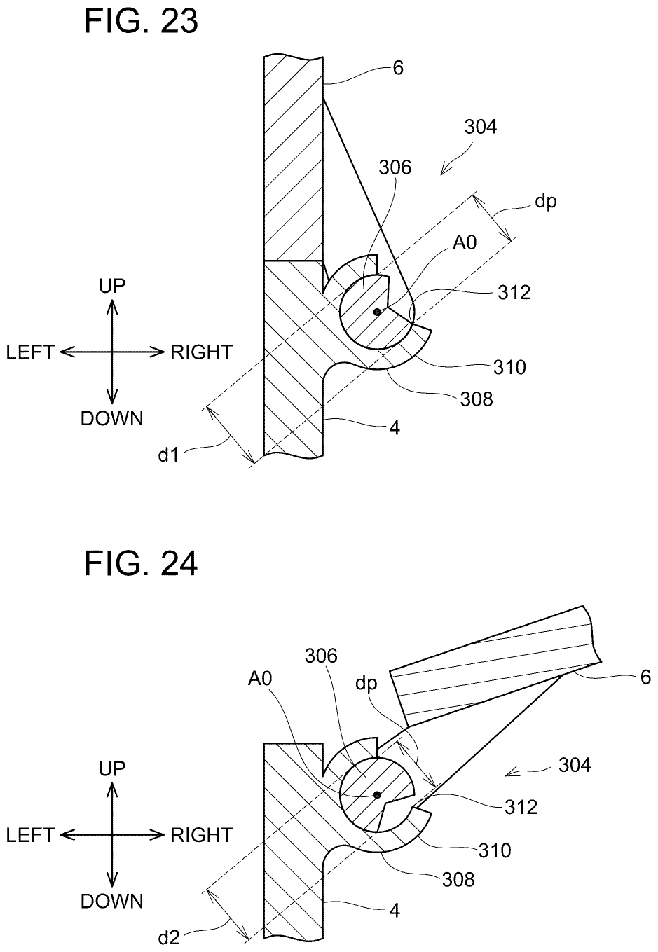

As shown in FIGS. 23 and 24, the lid 6 and the case body 4 are coupled to each other via the shaft 306 and the shaft holder 308 such that they are rotatable relative to each other about a rotation axis A0.

When the lid 6 is in the closed position as shown in FIG. 23, a width d1 of the shaft 306 in a direction parallel to the width direction of the shaft insertion passage 312 is greater than a width dp of the shaft insertion passage 312, and thus the user cannot pull out the shaft 306 from the tube 310 using a force. Specifically, even when the user attempts to pull the lid 6 away from the case body 4, the tube 310 does not deform to the extent where the shaft 306 can pass through the shaft insertion passage 312 (i.e., to the extent where the width dp of the shaft insertion passage 312 is expanded to the width d1 of the shaft 306). Therefore, when the lid 6 is in the closed position, the user cannot decouple the shaft 306 from the shaft holder 308 and thus cannot remove the lid 6 from the case body 4.

As the lid 6 opens as shown in FIG. 24, a width d2 of the shaft 306 in the direction parallel to the width direction of the shaft insertion passage 312 becomes less than the width d1 of the shaft 306 with the lid 6 in the closed position (see FIG. 23). Thus, the user can pull out the shaft 306 from the tube 310 using a force when the lid 6 is opened. Specifically, when the user attempts to pull the lid 6 away from the case body 4, the shaft 306 deforms the tube 310 such that the width of the shaft insertion passage 312 is expanded and eventually comes out from the tube 310 through the shaft insertion passage 312. Thus, when the lid 6 is opened, the user can decouple the shaft 306 from the shaft holder 308 to remove the lid 6 from the case body 4.

### Variants of Third Embodiment

The shape of the shaft 306 may be any shape (e.g., a prism) other than that shown in FIGS. 22 to 24 as long as the width of the shaft 306 in the direction parallel to the width direction of the shaft insertion passage 312 changes as the lid 6 is opened/closed.

The shaft 306 may be located on the case body 4 and the shaft holder 308 may be located on the lid 6, instead of the shaft 306 being located on the lid 6 and the shaft holder 308 being located on the case body 4.

### Features of Third Embodiment

In this embodiment, when the lid 6 is in the closed position, switching of the coupling mechanism 304 from the coupling state to the decoupled state is prohibited. When the lid 6 is in the open position, the switching of the coupling mechanism 304 from the coupling state to the decoupled state is permitted.

For example, from the perspective of safety, the user may wish to prevent decoupling of the lid 6 from the case body 4 when the posture of the charger 302 is unstable (e.g., when the user is carrying the charger 302). Normally, the lid 6 is expected to be in the closed position when the posture of the charger 302 is unstable. According to the configuration above, the lid 6 is prohibited from being decoupled from the case body 4 when the lid 6 is in the closed position. The lid 6 is permitted to be decoupled from the case body 4 when the lid 6 is in the open position. Thus, the configuration above prevents the lid 6 from being decoupled from the case body 4 when the posture of the charger 302 is unstable, and thus improves the safety of the charger 302.

In this embodiment, the charger 302 further comprises the lid 6 (an example of manipulatable portion) configured to be manually manipulated by the user. The coupling mechanism 304 is switched between the coupling state and the decoupled state by the lid 6 being manipulated.

The configuration above allows the user to switch the coupling mechanism 304 between the coupling state and the decoupled state by manually manipulating the lid 6, without using a tool (e.g., a screwdriver, a wrench). This allows the user to easily switch the coupling mechanism 304 between the coupling state and the decoupled state.

### Fourth Embodiment: Charger 402

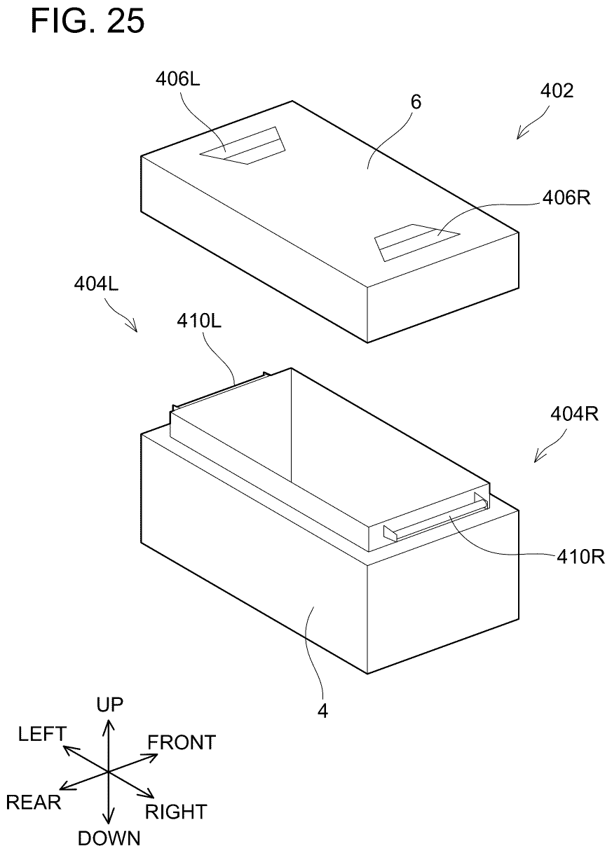

As shown in FIG. 25, a charger 402 is different from the charger 2 according to the first embodiment in that the former comprises a coupling mechanism 404L instead of the retainer 96 (see FIG. 2) and a coupling mechanism 404R instead of the coupling mechanism 34 (see FIG. 6). The charger 402 is substantially identical to the charger 2 according to the first embodiment, except for the above difference. The following description focuses on the coupling mechanisms 404L and 404R.

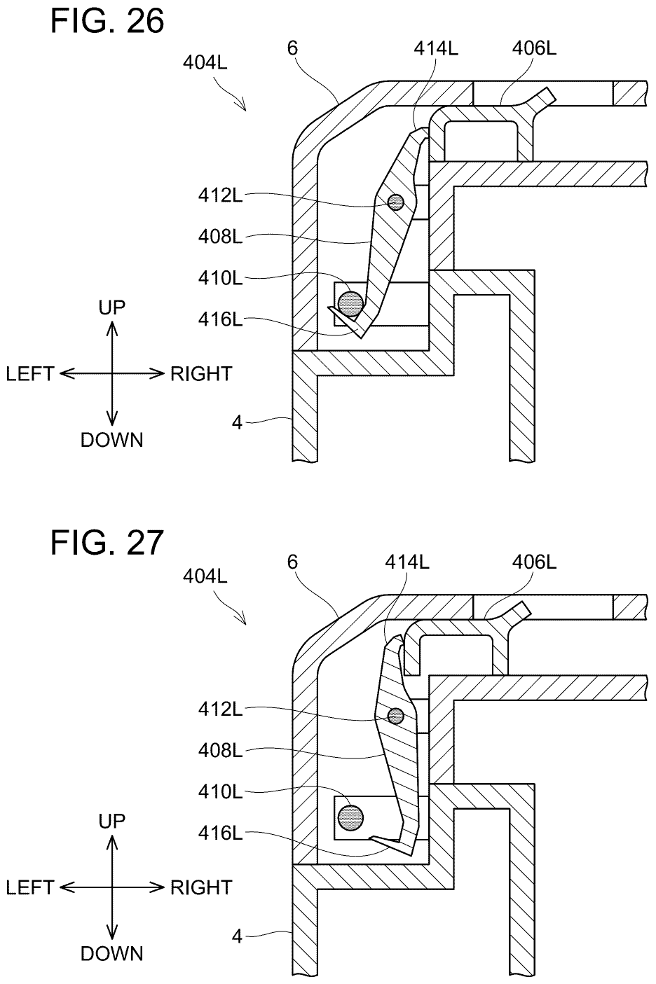

As shown in FIG. 26, the coupling mechanism 404L couples a left portion of the lid 6 and a left portion of the case body 4 to each other. The coupling mechanism 404L comprises a manipulatable plate 406L and a lock plate 408L on the lid 6 and a shaft 410L on the case body 4. The manipulatable plate 406L is slidable relative to the lid 6 in the left-right direction. The manipulatable plate 406L is exposed at the upper surface of the lid 6 and configured to be manually manipulated by the user. The lock plate 408L is supported on the lid 6 via a pin 412L extending in the front-rear direction. The lock plate 408L is rotatable about the pin 412L relative to the lid 6. The lock plate 408L comprises a press portion 414L located above the pin 412L and a claw portion 416L located below the pin 412L. The lock plate 408L is biased by a biasing member (e.g., a spring) (not shown) to assume the posture shown in FIG. 26 (i.e., the posture in which the press portion 414L is pressed against the left surface of the manipulatable plate 406L and the claw portion 416L is in engagement with the shaft 410L). The lid 6 and the case body 4 are coupled to each other by the claw portion 416L engaging with the shaft 410L. When the manipulatable plate 406L is moved leftward against the biasing force of the biasing member as shown in FIG. 27, the lock plate 408L is rotated about the pin 412L and the claw portion 416L is thereby disengaged from the shaft 410L. Thus, the user can release the coupling of the lid 6 with the case body 4 formed by the coupling mechanism 404L by manipulating the manipulatable plate 406L.

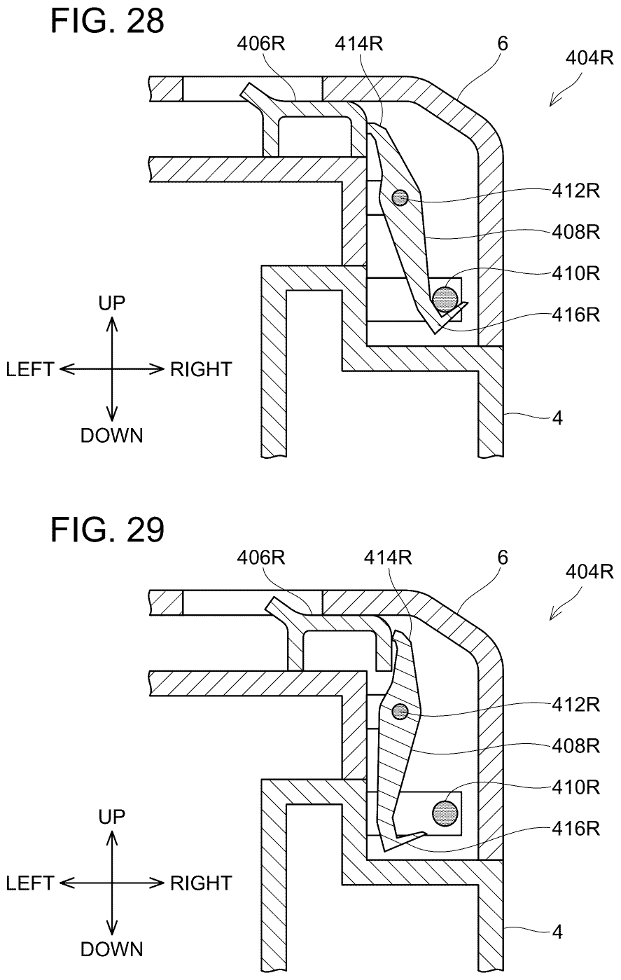

As shown in FIG. 28, the coupling mechanism 404R couples a right portion of the lid 6 and a right portion of the case body 4 to each other. The coupling mechanism 404R comprises a manipulatable plate 406R and a lock plate 408R on the lid 6 and a shaft 410R on the case body 4. The manipulatable plate 406R is slidable relative to the lid 6 in the left-right direction. The manipulatable plate 406R is exposed at the upper surface of the lid 6 and configured to be manually manipulated by the user. The lock plate 408R is supported on the lid 6 via a pin 412R extending in the front-rear direction. The lock plate 408R is rotatable about the pin 412R relative to the lid 6. The lock plate 408R comprises a press portion 414R located above the pin 412R and a claw portion 416R located below the pin 412R. The lock plate 408R is biased by a biasing member (e.g., a spring) (not shown) to assume the posture shown in FIG. 28 (i.e., the posture in which the press portion 414R is pressed against the right surface of the manipulatable plate 406R and the claw portion 416R is in engagement with the shaft 410R). The lid 6 and the case body 4 are coupled to each other by the claw portion 416R engaging with the shaft 410R. When the manipulatable plate 406R is moved rightward against the biasing force of the biasing member as shown in FIG. 29, the lock plate 408R is rotated about the pin 412R and the claw portion 416R is thereby disengaged from the shaft 410R. Thus, the user can release the coupling of the lid 6 with the case body 4 formed by the coupling mechanism 404R by manipulating the manipulatable plate 406R.

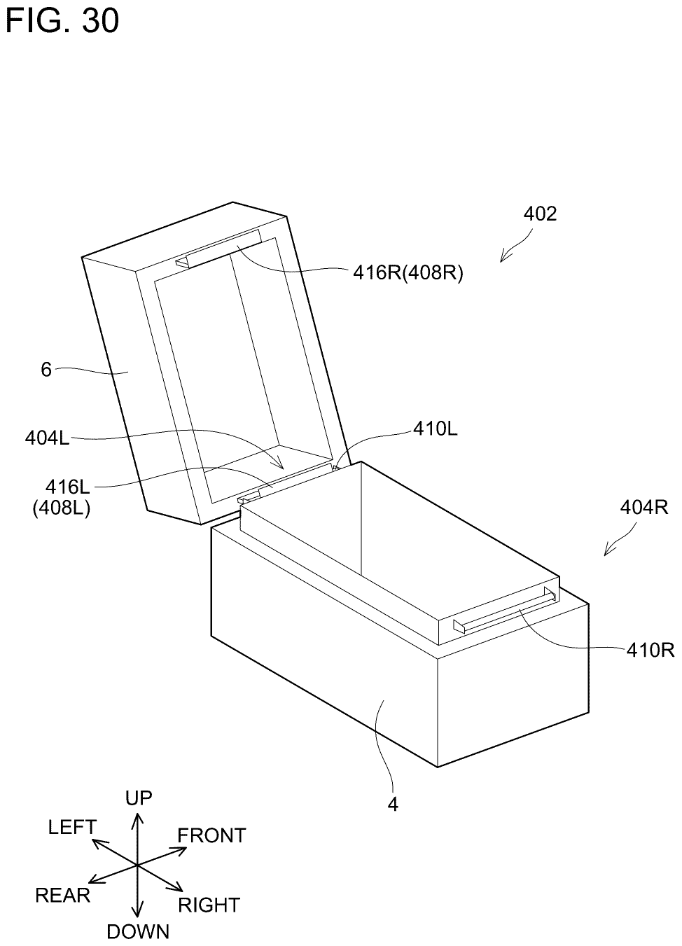

In the state where the coupling formed by the coupling mechanism 404R is released and the lid 6 and the case body 4 are coupled to each other only by the coupling mechanism 404L as shown in FIG. 30, the lid 6 is rotatable about the shaft 410L relative to the case body 4. In the state where the coupling formed by the coupling mechanism 404L is released and the lid 6 and the case body 4 are coupled to each other only by the coupling mechanism 404R, the lid 6 is rotatable about the shaft 410R relative to the case body 4, although this is not shown.

When both the coupling formed by the coupling mechanism 404L and the coupling formed by the coupling mechanism 404R are released as shown in FIG. 25, the lid 6 can be removed from the case body 4.

### Variant of Fourth Embodiment

The coupling mechanisms 404L and 404R may be disposed on side surfaces perpendicular to the short direction of the charger 402 (i.e., front and rear surfaces), respectively, instead of being disposed on the side surfaces perpendicular to the longitudinal direction of the charger 402 (i.e., left and right surfaces), respectively.

### Features of Fourth Embodiment

In this embodiment, the charger 402 further comprises the manipulatable plates 406L, 406R (examples of manipulatable portion) configured to be manually manipulated by the user. The coupling mechanisms 404L, 404R are switched between the coupling state and the decoupled state by the manipulatable plates 406L, 406R being manipulated.

The configuration above allows the user to switch the coupling mechanisms 404L, 404R between the coupling state and the decoupled state by manually manipulating the manipulatable plates 406L, 406R, without using a tool (e.g., a screwdriver, a wrench). This allows the user to easily switch the coupling mechanisms 404L, 404R between the coupling state and the decoupled state.

### Fifth Embodiment: Charger 502

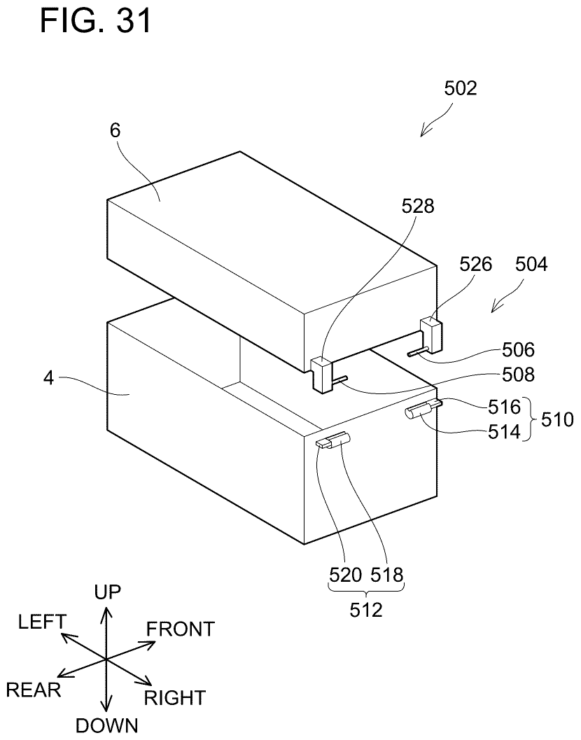

As shown in FIG. 31, a charger 502 is different from the charger 2 according to the first embodiment in that the former comprises a coupling mechanism 504 instead of the coupling mechanism 34 (see FIG. 6). The charger 502 is substantially identical to the charger 2 according to the first embodiment except for the above difference. The following description focuses on the coupling mechanism 504.

The coupling mechanism 504 comprises a front shaft 506 and a rear shaft 508 on the lid 6 and a front shaft holder 510 and a rear shaft holder 512 on the case body 4. The front shaft 506 is fixed to a front projection 526 located on the right surface of the lid 6. The front shaft 506 extends rearward from the rear surface of the front projection 526. The rear shaft 508 is fixed to a rear projection 528 located on the right surface of the lid 6. The rear shaft 508 extends forward from the front surface of the rear projection 528. The front shaft holder 510 comprises a front tubular member 514 configured to receive the front shaft 506 such that the front shaft 506 is rotatable therein and a front slide rail 516 supporting the front tubular member 514 such that the front tubular member 514 is slidable in the front-rear direction. The front tubular member 514 is configured to be manually manipulated by the user. The rear shaft holder 512 comprises a rear tubular member 518 configured to receive the rear shaft 508 such that the rear shaft 508 is rotatable therein and a rear slide rail 520 supporting the rear tubular member 518 such that the rear tubular member 518 is slidable in the front-rear direction. The rear tubular member 518 is configured to be manually manipulated by the user.

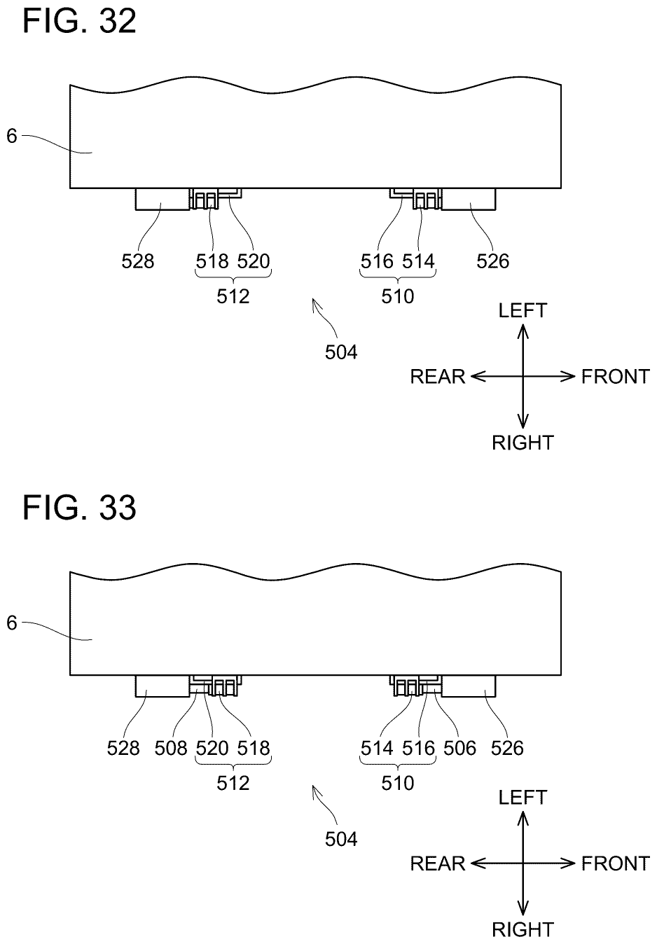

As shown in FIG. 32, the front tubular member 514 is normally snap-fitted to the front slide rail 516 at the position where the front shaft 506 (see FIG. 31) is inserted. In this state, the lid 6 and the case body 4 are coupled to each other via the front shaft 506 and the front tubular member 514 such that they are rotatable relative to each other. Further, the rear tubular member 518 is normally snap-fitted to the rear slide rail 520 at the position where the rear shaft 508 (see FIG. 31) is inserted. In this state, the lid 6 and the case body 4 are coupled to each other via the rear shaft 508 and the rear tubular member 518 such that they are rotatable relative to each other.

When the front tubular member 514 is moved rearward as shown in FIG. 33, the front shaft 506 comes out from the front tubular member 514. When the rear tubular member 518 is moved forward, the rear shaft 508 comes out from the rear tubular member 518. The coupling of the lid 6 with the case body 4 formed by the coupling mechanism 504 is thereby released, and thus the lid 6 can be removed from the case body 4.

### Variants of Fifth Embodiment

The front shaft 506 and the rear shaft 508 may be located on the case body 4 and the front shaft holder 510 and the rear shaft holder 512 may be located on the lid 6, instead of the front shaft 506 and the rear shaft 508 being located on the lid 6 and the front shaft holder 510 and the rear shaft holder 512 being located on the case body 4.

The coupling mechanism 504 may be located not only on the right surface of the charger 502 but also on the left surface of the charger 502. In this case, the user can select a direction in which the lid 6 opens relative to the case body 4 from among a plurality of directions. Specifically, after releasing the coupling formed by the coupling mechanism 504 on the right surface of the charger 502, the user can open the lid 6 upward and leftward relative to the case body 4. Alternatively, after releasing the coupling formed by the coupling mechanism 504 on the left surface of the charger 502, the user can open the lid 6 upward and rightward relative to the case body 4. The coupling mechanisms 504 may be disposed on side surfaces perpendicular to the short direction of the charger 502 (i.e., front and rear surfaces), respectively, instead of being disposed on the side surfaces perpendicular to the longitudinal direction of the charger 502 (i.e., left and right surfaces), respectively.

### Features of Fifth Embodiment

In this embodiment, the coupling mechanism 504 comprises the tubular members 514, 518 (examples of coupling member) each configured to be movable between the coupling position in which the tubular member couples the case body 4 and the lid 6 to each other (i.e., positions shown in FIG. 32) and the decoupled position in which the tubular member decouples the case body 4 and the lid 6 from each other (i.e., positions shown in FIG. 33).

The configuration above allows the user to switch the coupling mechanism 504 between the coupling state and the decoupled state by changing the positions of the tubular members 514, 518 between the coupling position and the decoupled position. This allows for a simple configuration of the coupling mechanism 504.

Further, in this embodiment, the charger 502 further comprises the tubular members 514, 518 (examples of manipulatable portion) configured to be manually manipulated by the user. The coupling mechanism 504 is switched between the coupling state and the decoupled state by the tubular members 514, 518 being manipulated.

The configuration above allows the user to switch the coupling mechanism 504 between the coupling state and the decoupled state by manually manipulating the tubular members 514, 518, without using a tool (e.g., a screwdriver, a wrench). This allows the user to easily switch the coupling mechanism 504 between the coupling state and the decoupled state.

### Sixth Embodiment: Charger 602

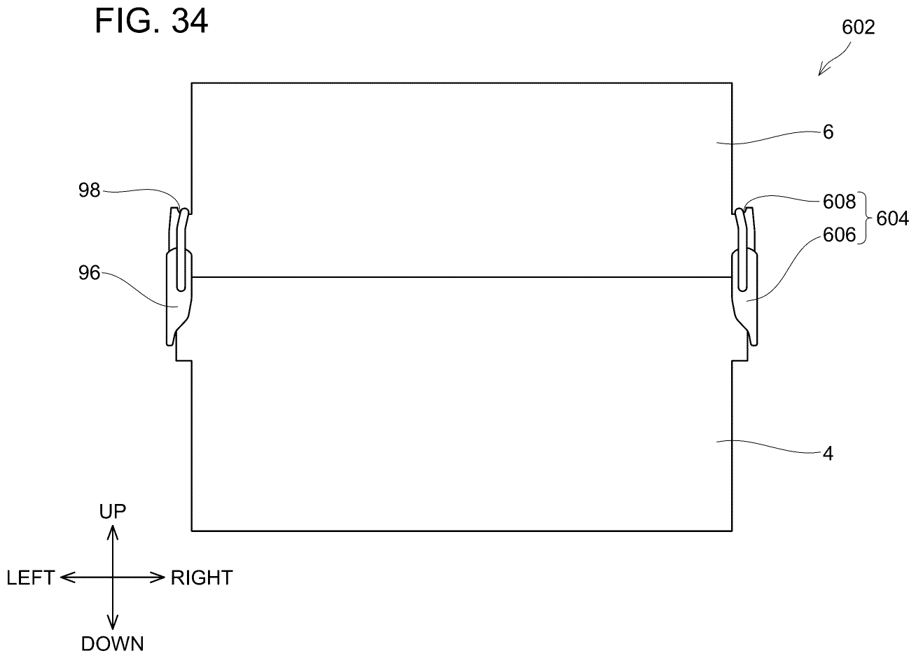

As shown in FIG. 34, a charger 602 is different from the charger 2 according to the first embodiment in that the former comprises a coupling mechanism 604 instead of the coupling mechanism 34 (see FIG. 6). The charger 602 is substantially identical to the charger 2 according to the first embodiment except for the above difference. The following description focuses on the coupling mechanism 604.

The coupling mechanism 604 comprises a retainer 606 on the case body 4 and a groove 608 defined in the lid 6. The retainer 606 engages with the groove 608, thereby coupling the lid 6 and the case body 4 to each other. The retainer 96 on the left surface of the case body 4 also engages with the groove 98, thereby coupling the lid 6 and the case body 4 to each other. Thus, the lid 6 and the case body 4 are coupled to each other via the two retainers 96, 606. The user can decouple the lid 6 from the case body 4 by disengaging the retainers 96, 606 from the grooves 98, 608, and thus can remove the lid 6 from the case body 4. The configuration of the retainer 606 is identical to that of the retainer 96, and the configuration of the groove 608 is identical to that of the groove 98.

### Variants of Sixth Embodiment

The retainers 96, 606 and the grooves 98, 608 may be disposed on side surfaces perpendicular to the short direction of the charger 602 (i.e., front and rear surfaces), respectively, instead of being disposed on the side surfaces perpendicular to the longitudinal direction of the charger 602 (i.e., left and right surfaces), respectively. Alternatively, a retainer 606 and a groove 608 may be located on each one of the four side surfaces (i.e., front, rear, left, and right surfaces) of the charger 602.

### Features of Sixth Embodiment

In this embodiment, the charger 602 further comprises the retainer 606 (an example of manipulatable portion) configured to be manually manipulated by the user. The coupling mechanism 604 is switched between the coupling state and the decoupled state by the retainer 606 being manipulated.

The configuration above allows the user to switch the coupling mechanism 604 between the coupling state and the decoupled state by manually manipulating the retainer 606, without using a tool (e.g., a screwdriver, a wrench). This allows the user to easily switch the coupling mechanism 604 between the coupling state and the decoupled state.

### Seventh Embodiment: Charger 702

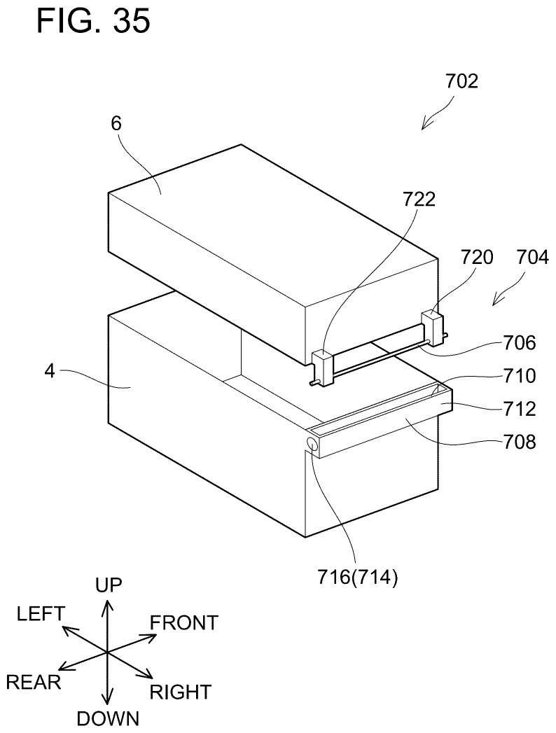

As shown in FIG. 35, a charger 702 is different from the charger 2 according to the first embodiment in that the former comprises a coupling mechanism 704 instead of the coupling mechanism 34 (see FIG. 6). The charger 702 is substantially identical to the charger 2 according to the first embodiment except for the above difference. The following description focuses on the coupling mechanism 704.

The coupling mechanism 704 comprises a shaft 706 on the lid 6 and a shaft holder 708 on the case body 4. The shaft 706 is fixed to a front projection 720 and a rear projection 722 that are located on the right surface of the lid 6. The shaft 706 extends in the front-rear direction and extends through the front projection 720 and the rear projection 722.

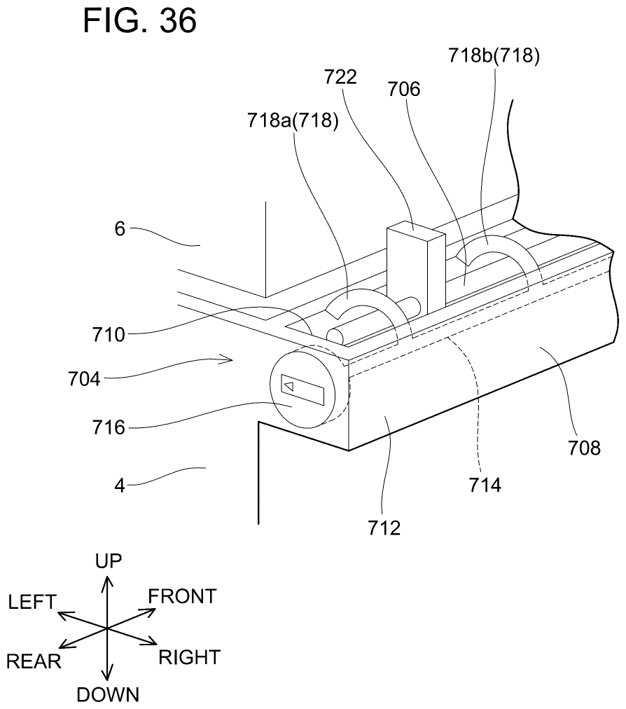

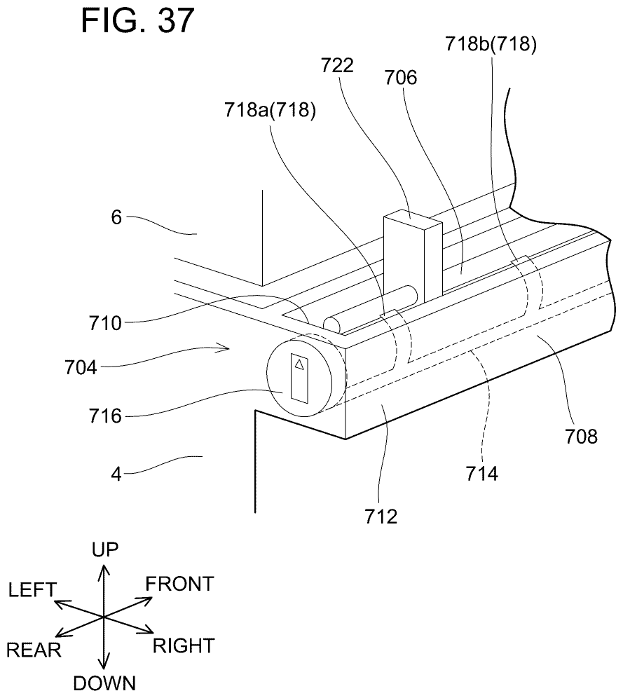

As shown in FIG. 36, the shaft holder 708 comprises a holder body 712 defining a recess 710 to house the shaft 706 therein and a lock member 714 incorporated in the holder body 712. The lock member 714 comprises a rotary knob 716 and lock pieces 718. The rotary knob 716 is exposed at a rear wall of the holder body 712 and configured to be manually manipulated by the user. The lock member 714 is configured to be movable relative to the holder body 712 between a lock position where the lock pieces 718 bridge over the recess 710 (see FIG. 36) and an unlock position where the lock pieces 718 do not bridge over the recess 710 (see FIG. 37). The user can move the lock member 714 between the lock position and the unlock position by rotating the rotary knob 716 of the lock member 714.

When the lock member 714 is in the lock position as shown in FIG. 36, the lock pieces 718 prohibit the shaft 706 from coming out from the recess 710. In this state, the lid 6 and the case body 4 are coupled to each other such that they are rotatable about the shaft 706.

When the lock member 714 is in the unlock position as shown in FIG. 37, the shaft 706 is permitted to come out from the recess 710. Thus, the user can pull the shaft 706 out from the recess 710 by moving the lid 6 upward relative to the case body 4 and thus can remove the lid 6 from the case body 4.

The lock pieces 718 comprise a first lock piece 718a located near and rearward of the rear projection 722 and a second lock piece 718b located near and forward of the rear projection 722. The lock pieces 718 further comprise a third lock piece located near and forward of the front projection 720 (see FIG. 35) and a fourth lock piece located near and rearward of the front projection 720, although this is not shown. Thus, the lock member 714 can lock the shaft 706 at multiple positions along the front-rear direction. This suppresses translation of the shaft 706 relative to the shaft holder 708, i.e., suppresses the lid 6 from rattling against the case body 4 compared to a configuration in which the shaft 706 is locked at one position along the front-rear direction.

### Variants of Seventh Embodiment

The lock member 714 may comprise a cylinder in which a key hole is formed, instead of the rotary knob 716, although this is not shown. In this case, the user may move the lock member 714 between the lock position and the unlock position by inserting a key to the key hole and rotating the cylinder along with the key. This key hole may have the same shape as the shape of the key hole of the padlock (not shown) used to lock the locking section 100 (see FIG. 2). Thus, a common key may be used to lock the locking section 100 and to move the lock member 714.

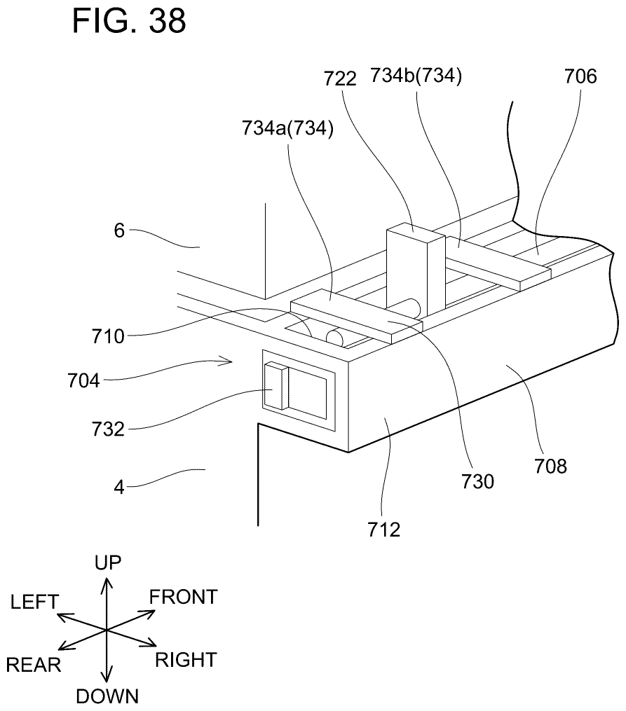

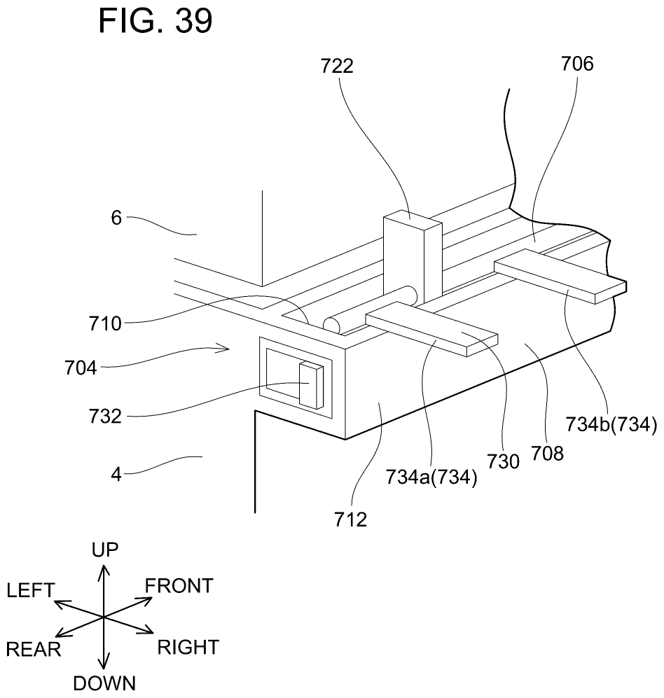

As shown in FIGS. 38 and 39, the shaft holder 708 may comprise a lock member 730 instead of the lock member 714. The lock member 730 comprises a slide knob 732 and lock pieces 734. The slide knob 732 is exposed at the rear wall of the holder body 712 and configured to be manually manipulated by the user. The slide knob 732 is slidable in the left-right direction relative to the holder body 712. The lock member 730 is configured to be movable relative to the holder body 712 between a lock position where the lock pieces 734 bridge over the recess 710 (see FIG. 38) and an unlock position where the lock pieces 734 do not bridges over the recess 710 (see FIG. 39).

When the slide knob 732 is slid leftward as shown in FIG. 38, the lock member 730 is moved to the lock position. When the lock member 730 is in the lock position, the lock pieces 734 prohibit the shaft 706 from coming out from the recess 710. In this state, the lid 6 and the case body 4 are coupled to each other such that they are rotatable about the shaft 706.

When the slide knob 732 is slid rightward as shown in FIG. 39, the lock member 730 is moved to the unlock position. When the lock member 714 is in the unlock position, the shaft 706 is permitted to come out from the recess 710. Thus, the user can pull the shaft 706 out from the recess 710 by moving the lid 6 upward relative to the case body 4 and thereby remove the lid 6 from the case body 4.

The lock pieces 734 comprises a first lock piece 734a located near and rearward of the rear projection 722 and a second lock piece 734b located near and forward of the rear projection 722. Although not illustrated, the lock pieces 734 further comprise a third lock piece located near and forward of the front projection 720 (see FIG. 35) and a fourth lock piece located near and rearward of the front projection 720. Thus, the lock member 730 can lock the shaft 706 at multiple positions along the front-rear direction. This suppresses translation of the shaft 706 relative to the shaft holder 708, i.e., suppresses the lid 6 from rattling against the case body 4 compared to a configuration in which the shaft 706 is locked at one position along the front-rear direction.

The recess 710 may be open in a direction other than the up direction. For example, the recess 710 may be open in the right direction. In this case, the lock member 730 may slide in the up-down direction to move between the lock position and the unlock position.

The coupling mechanism 704 may be located not only on the right surface of the charger 702 but also on the left surface of the charger 702. In this case, the user can select a direction in which the lid 6 opens relative to the case body 4 from among a plurality of directions. Specifically, after releasing the coupling formed by the coupling mechanism 704 on the right surface of the charger 702, the user can open the lid 6 upward and leftward relative to the case body 4. Alternatively, after releasing the coupling formed by the coupling mechanism 704 on the left surface of the charger 702, the user can open the lid 6 upward and rightward relative to the case body 4. The coupling mechanisms 704 may be disposed on side surfaces perpendicular to the short direction of the charger 702 (i.e., front and rear surfaces), respectively, instead of being disposed on the side surfaces perpendicular to the longitudinal direction of the charger 702 (i.e., left and right surfaces), respectively.

### Features of Seventh Embodiment

In this embodiment, the coupling mechanism 704 comprises the lock member 714 (or the lock member 730) (an example of coupling member) configured to be movable between the lock position (an example of coupling position) in which the lock member couples the case body 4 and the lid 6 to each other and the unlock position (an example of decoupled position) in which the lock member decouples the case body 4 and the lid 6 from each other.

The configuration above allows the user to switch the coupling mechanism 704 between the coupling state and the decoupled state by changing the position of the lock member 714 (or the lock member 730) between the lock position and the unlock position. This allows for a simple configuration of the coupling mechanism 704.

In this embodiment, the charger 702 further comprises the rotary knob 716 (or the slide knob 732) (an example of manipulatable portion) configured to be manually manipulated by the user. The coupling mechanism 704 is switched between the coupling state and the decoupled state by the rotary knob 716 (or the slide knob 732) being manipulated.

The configuration above allows the user to switch the coupling mechanism 704 between the coupling state and the decoupled state by manually manipulating the rotary knob 716 (or the slide knob 732), without using a tool (e.g., a screwdriver, a wrench). This allows the user to easily switch the coupling mechanism 704 between the coupling state and the decoupled state.

### Eighth Embodiment: Charger 802

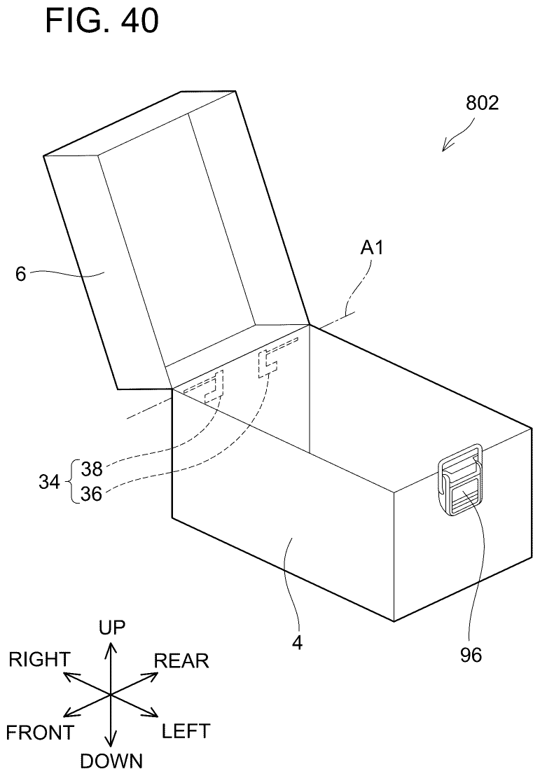

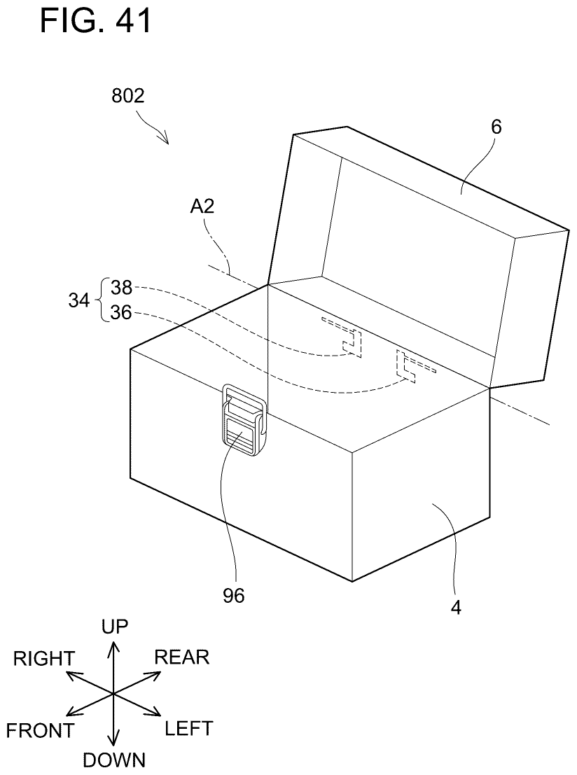

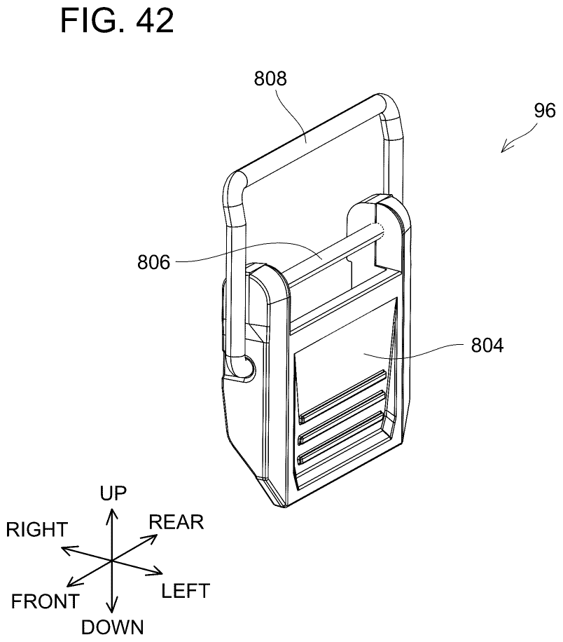

As shown in FIGS. 40 and 41, a charger 802 is different from the charger 2 according to the first embodiment in that the coupling mechanism 34 (see FIG. 6) can be selectively arranged on the right surface of the charger 802 or the rear surface of the charger 802 and that the retainer 96 (see FIG. 2) can be selectively arranged on the left surface of the charger 802 or the front surface of the charger 802. The charger 802 is identical to the charger 2 according to the first embodiment except for the above differences.

In this embodiment, a set of elements to attach/detach the coupling mechanism 34 (i.e., the first case-side tube 42, the first lid-side tube 44, the second case-side tube 48, the second lid-side tube 50, the guide 80, the engagement piece 86, and the engagement piece 90) (see FIG. 6) is located not only on the right surface of the charger 802 but also on the rear surface of the charger 802. Thus, the coupling mechanism 34 can be selectively arranged on the right surface or the rear surface of the charger 802.

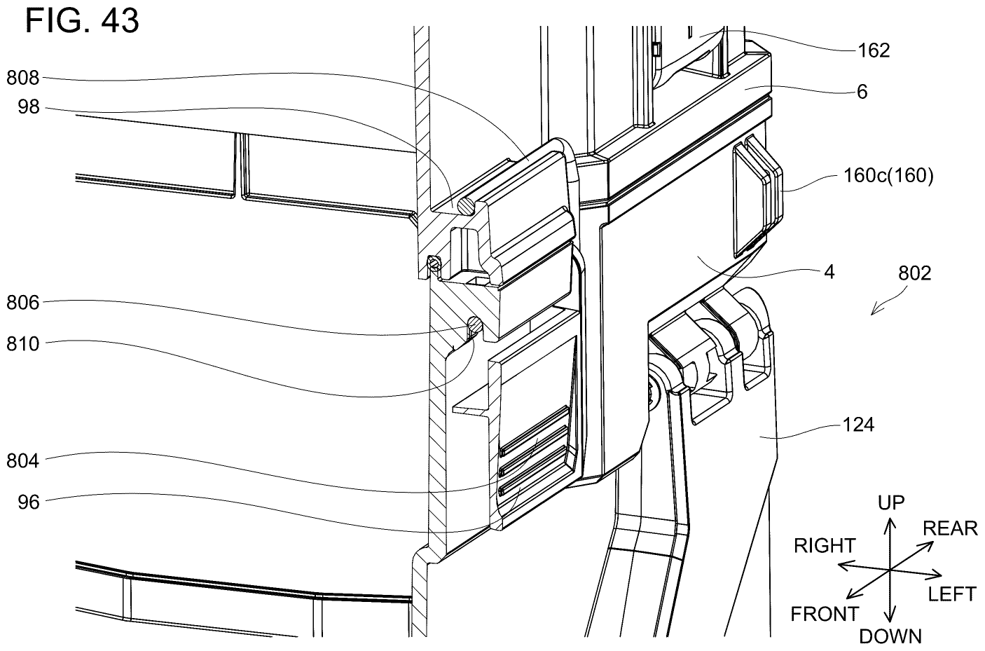

As shown in FIG. 42, the retainer 96 comprises a manipulatable plate 804 configured to be manipulated by the user, a pin 806 fixed to the manipulatable plate 804, and a latch 808 rotatably supported on the manipulatable plate 804. As shown in FIG. 43, the pin 806 is rotatably received in a groove 810 formed in the case body 4. Thus, the manipulatable plate 804 is rotatable about the pin 806 relative to the case body 4. The latch 808 engages with the groove 98 formed in the lid 6. When a lower portion of the manipulatable plate 804 is moved away from the case body 4 in the state shown in FIG. 43, the latch 808 is disengaged from the groove 98. After this, when the manipulatable plate 804 is moved downward relative to the case body 4, the pin 806 comes out from the groove 810 and thus the retainer 96 can be removed from the case body 4. In this embodiment, a set of elements for attachment/detachment of the retainer 96 (i.e., the groove 98 and the groove 810) is located not only on the left surface of the charger 802 but also on the front surface of the charger 802. Thus, the retainer 96 can be selectively arranged on the left surface or the front surface of the charger 802.

FIG. 40 shows the charger 802 with the coupling mechanism 34 arranged on the right surface of the charger 802 and the retainer 96 arranged on the left surface of the charger 802. In this charger 802, the coupling mechanism 34 couples the lid 6 and the case body 4 to each other such that they are rotatable about a first rotation axis A1 extending in the front-rear direction. The user first releases the coupling of the lid 6 with the case body 4 formed by the retainer 96 and then rotates the lid 6 about the first rotation axis A1 relative to the case body 4 to open and close the lid 6.

FIG. 41 shows the charger 802 with the coupling mechanism 34 arranged on the rear surface of the charger 802 and the retainer 96 arranged on the front surface of the charger 802. In this charger 802, the coupling mechanism 34 couples the lid 6 and the case body 4 to each other such that they are rotatable about a second rotation axis A2 extending in the left-right direction. The user first releases the coupling of the lid 6 with the case body 4 formed by the retainer 96 and then rotates the lid 6 about the second rotation axis A2 relative to the case body 4 to open and close the lid 6.

### Features of Eighth Embodiment

In this embodiment, the coupling state includes a first coupling state in which the coupling mechanism 34 couples the case body 4 and the lid 6 to each other such that the case body 4 and the lid 6 are rotatable relative to each other about the first rotation axis A1 and a second coupling state in which the coupling mechanism 34 couples the case body 4 and the lid 6 to each other such that the case body 4 and the lid 6 are rotatable relative to each other about the second rotation axis A2 different from the first rotation axis A1. The coupling mechanism 34 is configured to be switchable between the first coupling state, the second coupling state, and the decoupled state

According to the configuration above, an opening direction of the lid 6 relative to the case body 4 can be changed by switching the coupling mechanism 34 between the first coupling state and the second coupling state. This allows the user to change the opening direction of the lid 6 relative to the case body 4 according to the user's convenience.

What is claimed is:

1. An electrical device, comprising:
a case body defining a housing space;
a battery receptacle disposed on the case body, wherein a battery pack used as a power supply for a power tool is detachably attached to the battery receptacle;
an external terminal disposed on the case body and configured to be electrically connected to the battery pack via the battery receptacle;
a lid configured to be movable relative to the case body between an open position where the lid opens the housing space and a closed position where the lid closes the housing space; and
a coupling mechanism configured to be switchable between a coupling state in which the coupling mechanism couples the case body and the lid to each other and a decoupled state in which the coupling mechanism decouples the case body and the lid from each other.

2. The electrical device according to claim 1, wherein
when the lid is in the closed position, switching of the coupling mechanism from the coupling state to the decoupled state is prohibited, and
when the lid is in the open position, the switching of the coupling mechanism from the coupling state to the decoupled state is permitted.

3. The electrical device according to claim 1, wherein
the coupling mechanism comprises a coupling member configured to be movable between a coupling position in which the coupling member couples the case body and the lid to each other and a decoupled position in which the coupling member decouples the case body and the lid from each other,
the coupling state is a state in which the coupling member is in the coupling position, and the decoupled state is a state in which the coupling member is in the decoupled position.

4. The electrical device according to claim 3, wherein
the coupling member is attached on an outer surface of one of the case body and the lid.

5. The electrical device according to claim 3, wherein
the coupling member comprises an engagement portion configured to engage with one of the case body and the lid when the coupling member is in the coupling position.

6. The electrical device according to claim 3, wherein
one of the case body and the lid comprises a blocking portion configured to block movement of the coupling member from the coupling position to the decoupled position when the lid is in the closed position, and
the blocking portion does not block the movement of the coupling member from the coupling position to the decoupled position when the lid is in the open position.

7. The electrical device according to claim 3, wherein
the coupling member comprises:
a coupling pin configured to be inserted in both a case-side insertion element located on the case body and a lid-side insertion element located on the lid to couple the case body and the lid to each other such that the case body and the lid are rotatable relative to each other; and
a manipulatable portion fixed to the coupling pin and configured to be manipulated by a user,
the coupling position is a position in which the coupling pin is inserted in both the case-side insertion element and the lid-side insertion element, and
the decoupled position is a position in which the coupling pin is out of at least one of the case-side insertion element and the lid-side insertion element.

8. The electrical device according to claim 7, wherein
the manipulatable portion comprises a finger pad configured for the user to put a finger on, and
the finger pad is offset from the coupling pin in a radial direction of the coupling pin.

9. The electrical device according to claim 7, wherein
the manipulatable portion comprises a wall extending in a direction perpendicular to an axial direction of the coupling pin and configured to allow a plate element to contact thereto, and
the wall is offset from the coupling pin in a radial direction of the coupling pin.

10. The electrical device according to claim 1, wherein
the battery receptacle is disposed within the housing space.

11. The electrical device according to claim 10, wherein
the battery pack is attached to the battery receptacle by being slid along a predetermined sliding direction relative to the battery receptacle, and
the sliding direction is along a direction in which the housing space is opened.

12. The electrical device according to claim 1, further comprising a manipulatable portion configured to be manually manipulated by a user,
wherein the coupling mechanism is switched between the coupling state and the decoupled state by the manipulatable portion being manipulated.

13. The electrical device according to claim 1, wherein
the coupling state includes:
a first coupling state in which the coupling mechanism couples the case body and the lid to each other such that the case body and the lid are rotatable relative to each other about a first rotation axis; and
a second coupling state in which the coupling mechanism couples the case body and the lid to each other such that the case body and the lid are rotatable relative to each other about a second rotation axis different from the first rotation axis, and
the coupling mechanism is configured to be switchable between the first coupling state, the second coupling state, and the decoupled state.

14. A carrying case configured to allow a user to carry a battery pack used as a power supply for a power tool, the carrying case comprising:
a case body defining a housing space;
a lid configured to be movable relative to the case body between an open position in which the lid opens the housing space and a closed position in which the lid closes the housing space; and
a coupling mechanism configured to be switchable between a coupling state in which the coupling mechanism couples the case body and the lid to each other and a decoupled state in which the coupling mechanism decouples the case body and the lid from each other.

15. The carrying case according to claim 14, further comprising a battery receptacle disposed on the case body, wherein the battery pack is detachably attached to the battery receptacle.

16. The electrical device according to claim 2, wherein
the coupling mechanism comprises a coupling member configured to be movable between a coupling position in which the coupling member couples the case body and the lid to each other and a decoupled position in which the coupling member decouples the case body and the lid from each other,
the coupling state is a state in which the coupling member is in the coupling position,
the decoupled state is a state in which the coupling member is in the decoupled position,
the coupling member is attached on an outer surface of one of the case body and the lid,
the coupling member comprises an engagement portion configured to engage with one of the case body and the lid when the coupling member is in the coupling position,
one of the case body and the lid comprises a blocking portion configured to block movement of the coupling member from the coupling position to the decoupled position when the lid is in the closed position,
the blocking portion does not block the movement of the coupling member from the coupling position to the decoupled position when the lid is in the open position,
the coupling member comprises:
a coupling pin configured to be inserted in both a case-side insertion element located on the case body and a lid-side insertion element located on the lid to couple the case body and the lid to each other such that the case body and the lid are rotatable relative to each other; and
a manipulatable portion fixed to the coupling pin and configured to be manipulated by a user,
the coupling position is a position in which the coupling pin is inserted in both the case-side insertion element and the lid-side insertion element,
the decoupled position is a position in which the coupling pin is out of at least one of the case-side insertion element and the lid-side insertion element,
the manipulatable portion comprises a finger pad configured for the user to put a finger on,
the finger pad is offset from the coupling pin in a radial direction of the coupling pin,
the manipulatable portion comprises a wall extending in a direction perpendicular to an axial direction of the coupling pin and configured to allow a plate element to contact thereto,
the wall is offset from the coupling pin in a radial direction of the coupling pin,
the battery receptacle is disposed within the housing space,
the battery pack is attached to the battery receptacle by being slid along a predetermined sliding direction relative to the battery receptacle, and
the sliding direction is along a direction in which the housing space is opened.

17. The carrying case according to claim 15, wherein
when the lid is in the closed position, switching of the coupling mechanism from the coupling state to the decoupled state is prohibited,
when the lid is in the open position, the switching of the coupling mechanism from the coupling state to the decoupled state is permitted,
the coupling mechanism comprises a coupling member configured to be movable between a coupling position in which the coupling member couples the case body and the lid to each other and a decoupled position in which the coupling member decouples the case body and the lid from each other,
the coupling state is a state in which the coupling member is in the coupling position,
the decoupled state is a state in which the coupling member is in the decoupled position,
the coupling member is attached on an outer surface of one of the case body and the lid,
the coupling member comprises an engagement portion configured to engage with one of the case body and the lid when the coupling member is in the coupling position,
one of the case body and the lid comprises a blocking portion configured to block movement of the coupling member from the coupling position to the decoupled position when the lid is in the closed position,
the blocking portion does not block the movement of the coupling member from the coupling position to the decoupled position when the lid is in the open position,
the coupling member comprises:
a coupling pin configured to be inserted in both a case-side insertion element located on the case body and a lid-side insertion element located on the lid to couple the case body and the lid to each other such that the case body and the lid are rotatable relative to each other; and
a manipulatable portion fixed to the coupling pin and configured to be manipulated by the user,
the coupling position is a position in which the coupling pin is inserted in both the case-side insertion element and the lid-side insertion element,
the decoupled position is a position in which the coupling pin is out of at least one of the case-side insertion element and the lid-side insertion element,
the manipulatable portion comprises a finger pad configured for the user to put a finger on,
the finger pad is offset from the coupling pin in a radial direction of the coupling pin,
the manipulatable portion comprises a wall extending in a direction perpendicular to an axial direction of the coupling pin and configured to allow a plate element to contact thereto,
the wall is offset from the coupling pin in a radial direction of the coupling pin,
the battery receptacle is disposed within the housing space,
the battery pack is attached to the battery receptacle by being slid along a predetermined sliding direction relative to the battery receptacle, and
the sliding direction is along a direction in which the housing space is opened.
